(19) United States
(12) Patent Application Publication
(10) Pub. No.: US 2025/0384495 A1
(43) Pub. Date: Dec. 18, 2025

(54) ARTIFICIAL INTELLIGENCE COMPUTING SYSTEMS AND METHODS FOR KITCHEN ORDER PREPARATION COORDINATION

(71) Applicant: TechRyde Inc., Niagara Falls (CA)

(72) Inventor: Sandeep Mahal, St. Catharines (CA)

(21) Appl. No.: 18/949,469

(22) Filed: Nov. 15, 2024

Related U.S. Application Data
(60) Provisional application No. 63/659,907, filed on Jun. 14, 2024.

(51) Int. Cl. G06Q 50/12; G06Q 10/0631

(52) U.S. Cl. CPC G06Q 50/12; G06Q 10/063114

(57) ABSTRACT

A computing system coordinates food order preparation in a kitchen establishment. The computing system receives food orders and extracts data (e.g., order type, customer information, food dataset identifying subset food items, and a timestamp associated with each food order). The availability of kitchen staff and the kitchen equipment are obtained. The data is inputted into a machine learning model to compute a first subset of the plurality of food orders that is classified with a cook status, and a second subset of the plurality of food orders that is classified with an on-hold status. Food orders in the second subset are each associated with a priority ranking used to generate a sequenced list of the food orders in the second subset. The first subset and the second subset are transmitted for display. The food orders in the second subset are displayed in an order according to their priority ranking.

### CROSS REFERENCE TO RELATED APPLICATION

This patent application claims priority to U.S. Provisional Patent Application No. 63/659,907, filed on Jun. 14, 2024 and titled “METHOD AND SYSTEM FOR OPTIMIZING KITCHEN ORDER PREPARATION USING ARTIFICIAL INTELLIGENCE AND MACHINE LEARNING”, the entire contents of which are hereby incorporated by reference.

### TECHNICAL FIELD

This application relates to artificial intelligence computing systems and methods for kitchen order preparation coordination.

### BACKGROUND

In the fast-paced realm of modern kitchen establishments, efficiently managing kitchen order preparation and table turn time is desirable. In some cases, existing processes rely on manual handling of orders in the kitchen. Some existing computing systems are used to receive food orders (via food delivery applications), and then prioritize the orders for the kitchen staff to fulfill (e.g., cook or prepare) based on delivery couriers. In some cases, the existing computing systems operate on a first-come-first-serve sequencing.

Kitchen establishments manage orders from dine-in, take-out, or delivery customers, or a combination thereof, using a systems, processes, and communication tools. For dine-in orders, customers typically place their orders through servers or self-service kiosks. These orders are entered into the restaurant's point of sale (POS) system and sent directly to the kitchen for preparation. In some cases, existing kitchen computing systems output the orders in a first-in-first-out (FIFO) sequence. In other words, a first order (e.g., a data input) received first at the kitchen computing system and a second order received second at the kitchen computing system generates an output that includes ranking the first order above the second order.

Take-out orders are typically placed by phone, online, or in person, and are also processed through the POS system, which sends the order to the kitchen. The kitchen prepares and packages the food for transport.

For delivery orders, customers typically order through third-party software platforms such as those under the tradenames UberEats, Door Dash and similar, or directly through the dining establishment's website. The POS system integrates with the one or more third-party software platforms, receiving and processing the order in real-time. The kitchen prepares and packages the food for transport.

Existing computing systems lack sufficient information and utilization of information, which may lead to longer wait times, inefficient resource utilization, and diminished customer satisfaction. In some cases, this causes food to be delivered to the customer later than desired. In some cases, this causes warm food to be delivered to the customer at a cooler temperature than desired.

### SUMMARY

The following summary is intended to introduce the reader to various aspects of the detailed description, but not to define or delimit any invention.

In at least one broad aspect, an on-premise computing system is provided, comprising: a communication system configured to receive a plurality of food orders and to communicate with one or more on-premise display devices; a memory comprising a machine learning (ML) model, and a local database configured to store kitchen staff status data and kitchen equipment status data; and a processor. The processor is configured to at least, for each food order: extract an order type, a customer name, a food dataset identifying one or more subset food items, and a timestamp associated with the food order, wherein the order type is selected from a group comprising at least a dine-in type, a delivery type, and a take-away type; access the local database to retrieve a number of current dine-in type orders, a number of currently pending delivery type orders, a number of currently pending take-away type orders, data regarding previous order completion times, table turn data, a current availability of a kitchen staff member and a current availability of a kitchen equipment associated with preparation of the one or more subset food items; and input an input data set into the ML model, the input data set comprising: the order type, the customer name, the food dataset identifying the one or more subset food items, the timestamp associated with the food order, the number of current dine-in type orders, the number of currently pending delivery type orders, the number of currently pending take-away type orders, the data regarding previous order completion times, table turn data, the current availability of the kitchen staff member and the current availability of the kitchen equipment. The processor is further configured to compute, using the ML model, a first subset of the plurality of food orders that is classified with a cook status, and a second subset of the plurality of food orders that is classified with an on-hold status. In some cases, each of the food orders in the second subset is associated with a priority ranking used to generate a sequenced list of the food orders in the second subset. The processor is further configured to transmit the first subset and the second subset for display on the one or more on-premise display devices, and wherein each of the food orders in the second subset are displayed in an order according to their respective priority ranking.

In some cases, each of the one or more food orders in the first subset is displayed respectively with one or more increasing time counters indicating a time elapsed since each of the one or more food orders in the first subset was classified with the cook status.

In some cases, the ML model computes, for each of the one or more food orders in the second subset, one or more estimated future times at which each respective on-hold status will automatically change to the cook status; and wherein each of the one or more food orders in the second subset is displayed respectively with one or more decreasing time counters each indicating a time remaining to the respective estimated future time at which the on-hold status will automatically change to the cook status.

In some cases, when a current time matches a given estimated future time associated with a given food order in the second subset, the given food order in the second subset is reclassified with the cook status and moved into the first subset.

In some cases, each of the one or more food orders in the second subset is further associated with a holding reason, and wherein the ML model computes the holding reason.

In some cases, the holding reason is in a natural language format, and the holding reason is displayed respectively with each of the one or more food orders in the second subset.

In some cases, the holding reason comprises: waiting for a specific ingredient, a higher priority food order takes precedence, a kitchen resource constraint, or a combination thereof.

In some cases, the communication system is configured to communicate with an external mapping system, and wherein the processor is configured to further: extract a customer address associated with each food order; when the order type is the delivery type, transmit the customer address and a kitchen address, which are receivable by the external mapping system, and, in response, receive a delivery time and a weather condition associated with a delivery of the food order, which are transmittable by the external mapping system; and wherein the input data set further comprises the customer address, the delivery time and the weather condition.

In some cases, when a new food order is received, the processor is configured to automatically re-execute the ML model using the new food order and at least the second subset of the plurality of food orders to compute a new sequenced list, wherein the new sequenced list comprises the new food order that is associated with the on-hold status.

In some cases, the first subset of the plurality of food orders comprises a first food item that is part of a given food order; the second subset of the plurality of food orders comprises a second food item that is part of the same given food order; the first food item is associated with a first preparation time x; the second food item is associated with a second preparation time y that is less than the first preparation time x; and the processor is configured to change the hold status of the second food item to the cook status approximately (x−y) minutes after receiving an indication that the first food item has started being prepared.

In some cases, the processor extracts a customer loyalty status associated with the customer name; the local database comprises a customization rule specifying to prioritize a given food order with a high loyalty status; and the customization rule and the customer loyalty status associated with the customer name are inputted into the ML model.

In some cases, the processor provides an ordering application comprising a graphical user interface (GUI) for display, and the processor is further configured to: provide, via the GUI, a plurality of prioritization parameters; receive, via the GUI, user input identifying one or more selected prioritization parameters for activation from amongst the plurality of prioritization parameters; re-train the ML model to apply the one or more selected prioritization parameters; and deploy the re-trained ML model at least when subsequently receiving a new food order.

In some cases, the memory further comprises a predictive ML model, and the processor is configured to execute the predictive ML model to compute a food order volume forecast.

In some cases, the processor is configured to execute the predictive ML model to further compute a pattern associated with a food order volume forecast.

In some cases, the processor is configured to: receive a natural language user input for analytics information; use a large language model to generate a structured query based on the natural language user input; use the structured query to obtain structured data from a database that stores thereon preparation metrics associated with the plurality of food orders; process the structured data using the large language model to generate at least a natural language explanation responsive to the natural language user input for analytics information; and output the natural language explanation.

In at least another broad aspect, there is provided an on-premise computing system comprising: a communication system configured to receive a plurality of food orders, to communicate with an external mapping system, and to communicate with one or more on-premise display devices; a memory comprising a machine learning (ML) model, and a local database configured to store kitchen staff status data and kitchen equipment status data; and a processor. The processor is configured to, for each food order: extract a customer name, a customer address, a food dataset identifying one or more subset food items, and a timestamp associated with the food order; transmit the customer address and a kitchen address, which are receivable by the external mapping system, and receive a delivery time and a weather condition associated with a delivery of the food order, which are transmittable by the external mapping system; and access the local database to retrieve a current availability of a kitchen staff member and a current availability of a kitchen equipment associated with preparation of the one or more subset food items. The processor is also configured to: input the customer name, the customer address, the food dataset identifying the one or more subset food items, the timestamp associated with the food order, the delivery time, the weather condition, the current availability of the kitchen staff member and the current availability of the kitchen equipment into the ML model; compute, using the ML model, a first subset of the plurality of food orders that is classified with a cook status, and a second subset of the plurality of food orders that is classified with an on-hold status; wherein each of one or more food orders in the second subset is associated with a priority ranking used to generate a sequenced list of the one or more food orders in the second subset; and, transmit the first subset and the second subset for display on the one or more on-premise display devices, and wherein each of the one or more food orders in the second subset are displayed in an order according to their respective priority ranking.

In some cases, each of the one or more food orders in the first subset is displayed respectively with one or more increasing time counters indicating a time elapsed since each of the one or more food orders in the first subset was classified with the cook status.

In some cases, the ML model computes for each of the one or more food orders in the second subset one or more estimated future times at which each respective on-hold status will automatically change to the cook status; and wherein each of the one or more food orders in the second subset is displayed respectively with one or more decreasing time counters each indicating a time remaining to the respective estimated future time at which the on-hold status will automatically change to the cook status.

In some cases, when a current time matches a given estimated future time associated with a given food order in the second subset, the given food order in the second subset is reclassified with the cook status and moved into the first subset.

In some cases, each of the one or more food orders in the second subset is further associated with a holding reason, and wherein the ML model computes the holding reason.

In some cases, the holding reason comprises: waiting for a specific ingredient, a higher priority food order takes precedence, a kitchen resource constraint, or a combination thereof.

In some cases, when a new food order is received, the processor is configured to automatically re-execute the ML model using the new food order and at least the second subset of the plurality of food orders to compute a new sequenced list, wherein the new sequenced list comprises the new food order that is associated with the on-hold status.

In some cases, the first subset of the plurality of food orders comprises a first food item that is part of a given food order; the second subset of the plurality of food orders comprises a second food item that is part of the first food order; the first food item is associated with a first preparation time x; the second food item is associated with a second preparation time y that is less than the first preparation time x; and the processor is configured to change the hold status of the second food item to the cook status approximately (x-y) minutes after receiving an indication that the first food item has started being prepared.

In some cases, the processor extracts a customer loyalty status associated with the customer name; the local database comprises a customization rule specifying to prioritize a given food order with a high loyalty status; and the customization rule and the customer loyalty status associated with the customer name are inputted into the ML model.

In some cases, the processor extracts a customer loyalty status associated with the customer name from an external customer loyalty server.

In some cases, the memory further stores a predictive ML model, and the processor is configured to execute the predictive ML model to compute a food order volume forecast.

In some cases, the processor is configured to execute the predictive ML model to further compute a pattern associated with the food order volume forecast.

In some cases, the processor is configured to: receive a natural language user input for analytics information; use a large language model to generate a structured query based on the natural language user input; use the structured query to obtain structured data from a database that stores thereon preparation metrics associated with the plurality of food orders; process the structured data using the large language model to generate at least a natural language explanation responsive to the natural language user input for analytics information; and output the natural language explanation.

In at least another broad aspect, a method is provided that is executed in a computing environment comprising one or more processors and memory. The method comprising: receiving a plurality of food orders; extracting a customer name, a customer address, a food dataset identifying one or more subset food items, and a timestamp associated with each food order of the plurality of food orders; transmitting the customer address and a kitchen address, which are receivable by the external mapping system, and receive a delivery time and a weather condition associated with a delivery of each of the food orders, which are transmittable by the external mapping system; accessing the local database to retrieve a current availability of a kitchen staff member and a current availability of a kitchen equipment associated with preparation of the one or more subset food items for each food order; inputting the customer name, the customer address, the food dataset identifying the one or more subset food items, the timestamp associated with the food order, the delivery time, the weather condition, the current availability of the kitchen staff member and the current availability of the kitchen equipment into an ML model for each food order; computing, using the ML model, a first subset of the plurality of food orders that is classified with a cook status, and a second subset of the plurality of food orders that is classified with an on-hold status; wherein each of one or more food orders in the second subset is associated with a priority ranking used to generate a sequenced list of the one or more food orders in the second subset; and transmitting the first subset and the second subset for display, and wherein each of the one or more food orders in the second subset are displayed in an order according to their respective priority ranking.

In at least another broad aspect, there is provided an on-premise computing system comprising: a communication system configured to receive a plurality of food orders, to communicate with an external mapping system, and to communicate with a plurality of on-premise computing devices; a memory comprising a machine learning (ML) model configured to compute a sequenced list that comprises the plurality of food orders, and a local database configured to store kitchen staff status data and kitchen equipment status data; and a processor. The processor is configured to, for each food order: extract a customer name, a customer address, a food dataset identifying one or more subset food items, and a timestamp associated with the food order; transmit the customer address and a kitchen address, which are receivable by the external mapping system, and receive a delivery time and a weather condition associated with a delivery of the food order, which are transmittable by the external mapping system; access the local database to retrieve a current availability of a kitchen staff member and a current availability of a kitchen equipment associated with preparation of the one or more subset food items; and input the customer name, the customer address, the food dataset identifying the one or more subset food items, the timestamp associated with the food order, the delivery time, the weather condition, the current availability of the kitchen staff member and the current availability of the kitchen equipment into the ML model. The processor is also configured to: compute, using the ML model, the sequenced list of the plurality of food orders, wherein a first subset of the plurality of food orders in the sequenced list is associated with a cook status and a second subset of the plurality of food orders in the sequenced list is associated with a hold status; wherein each one of the plurality of food orders in the second subset in the sequenced list is further associated with a holding reason in a text format, and wherein the ML model computes the holding reason. The processor is also configured to transmit at least the first subset of the plurality of food orders in the sequenced list to the plurality of on-premise computing devices.

In some cases, when a new food order is received, the processor is configured to re-execute the ML model using the new food order and at least the second subset of the plurality of food orders in the sequenced list to compute a new sequenced list, wherein the new sequenced list comprises the new food order that is associated with the cook status or the hold status.

In some cases, the holding reason comprises: waiting for a specific ingredient, a higher priority food order takes precedence, a kitchen resource constraint, or a combination thereof.

In some cases, each one of the plurality of food orders in the second subset in the sequenced list is further associated with an estimated release time for when a given food order with the hold status will transition to the cook status, and wherein the ML model computes the estimated release time.

In some cases, the first subset of the plurality of food orders comprises a first food item that is part of a first food order; the second subset of the plurality of food orders comprises a second food item that is part of the first food order; the first food item is associated with a first preparation time x; the second food item is associated with a second preparation time y that is less than the first preparation time x; and the processor is configured to change the hold status of the second food item to the cook status approximately (x-y) minutes after receiving an indication that the first food item has started being prepared.

In some cases, the processor extracts a customer loyalty status associated with the customer name; the local database comprises a customization rule specifying to prioritize a given food order with a high loyalty status; and the customization rule and the customer loyalty status associated with the customer name are inputted into the ML model.

In some cases, the processor extracts a customer loyalty status associated with the customer name from an external customer loyalty server.

In some cases, the memory further comprises a predictive ML model, and the processor is configured to execute the predictive ML model to compute a food order volume forecast.

In some cases, the processor is configured to execute the predictive ML model to further compute a pattern associated with the food order volume forecast.

In some cases, the processor is configured to: receive a user input, the user input comprising a request for analytics; generate a query based on the user input; obtain data from the database based on the query, the data relating to the request for analytics; process the obtained data and generate at least one reason associated with the request for analytics; and provide the processed obtained data and the at least one reason to the user.

In another broad aspect, a method is provided comprising: receiving a plurality of food orders; extracting a customer name, a customer address, a food dataset identifying one or more subset food items, and a timestamp associated with each food order of the plurality of food orders; transmitting the customer address and a kitchen address, which are receivable by the external mapping system, and receive a delivery time and a weather condition associated with a delivery of each of the food orders, which are transmittable by the external mapping system; accessing the local database to retrieve a current availability of a kitchen staff member and a current availability of a kitchen equipment associated with preparation of the one or more subset food items for each food order; inputting the customer name, the customer address, the food dataset identifying the one or more subset food items, the timestamp associated with the food order, the delivery time, the weather condition, the current availability of the kitchen staff member and the current availability of the kitchen equipment into an ML model for each food order; and computing, using the ML model, a sequenced list of the plurality of food orders, wherein a first subset of the plurality of food orders in the sequenced list is associated with a cook status and a second subset of the plurality of food orders in the sequenced list is associated with a hold status. Each food order of the plurality of food orders in the second subset in the sequenced list is further associated with a holding reason in a text format, and wherein the ML model computes the holding reason. The method further comprises transmitting at least the first subset of the plurality of food orders in the sequenced list to the plurality of on-premise computing devices.

In some cases, when a new food order is received, the method further comprises re-executing the ML model using the new food order and at least the second subset of the plurality of food orders in the sequenced list to compute a new sequenced list, wherein the new sequenced list comprises the new food order that is associated with the cook status or the hold status.

In some cases, the holding reason comprises: waiting for a specific ingredient, a higher priority food order takes precedence, a kitchen resource constraint, or a combination thereof.

In some cases, each one of the plurality of food orders in the second subset in the sequenced list is further associated with an estimated release time for when a given food order with the hold status will transition to the cook status, and wherein the ML model computes the estimated release time.

In some cases, the first subset of the plurality of food orders comprises a first food item that is part of a first food order; the second subset of the plurality of food orders comprises a second food item that is part of the first food order; the first food item is associated with a first preparation time x; the second food item is associated with a second preparation time y that is less than the first preparation time x; and the method further comprises changing the hold status of the second food item to the cook status approximately (x-y) minutes after receiving an indication that the first food item has started being prepared.

In some cases, the method further comprises extracting a customer loyalty status associated with the customer name, wherein a customization rule specifies prioritizing a given food order with a high loyalty status, and wherein the customization rule and the customer loyalty status are associated with the customer name are inputted into the ML model.

In some cases, the method further comprises extracting a customer loyalty status associated with the customer name from an external customer loyalty server.

In some cases, the method further comprises computing a food order volume forecast with a predictive ML model.

In some cases, the method further comprises executing the predictive ML model to further compute a pattern associated with the food order volume forecast.

In some cases, the method further comprises: receiving a user input, the user input comprising a request for analytics; generating a query based on the user input; obtaining data from the database based on the query, the data relating to the request for analytics; processing the obtained data and generate at least one reason associated with the request for analytics; and providing the processed obtained data and the at least one reason to the user.

In some cases, a method is provided for coordinating kitchen order preparation. The method includes: receiving multiple orders, each with various preparation stages; extracting data from a database, including order details and timestamps; engineering features such as order size, value, and service level agreement requirements; integrating external factors like weather and traffic; collecting data on kitchen equipment and staff availability; including customer feedback and preferences in prioritization decisions; estimating preparation times dynamically based on real-time data; using predictive modeling to forecast order volume and demand patterns; allowing manual customization of prioritization rules; and establishing a real-time feedback loop to refine ML models continuously.

In some cases, a computing system is provided for coordinating kitchen order preparation, comprising: an order receiving unit for collecting incoming orders and relevant data; a data processing unit for extracting and preprocessing data from a MySQL database; a feature engineering module for developing and calculating features relevant to order prioritization; an environmental data integration module for incorporating external factors affecting order preparation; a kitchen resource management module for tracking and managing available kitchen equipment and staff; a customer feedback module for gathering and analyzing customer feedback to inform prioritization; a predictive modeling engine for using ML algorithms to forecast order volumes and demand patterns; a real-time feedback loop for continuously updating the system based on real-time data and feedback; and a customization interface for allowing manual input and rule definition for order prioritization.

In some cases, the data extraction includes timestamps, order types, order items, customer details, and special requests.

In some cases, external factors includes weather conditions, traffic congestion, and special events.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 illustrates a computing system for dynamically controlling preparation of kitchen food orders in accordance with at least one embodiment;

FIG. 2 illustrates a block diagram of a computer in accordance with at least one embodiment;

FIG. 3 illustrates a process for training an artificial intelligence (AI) model of the system in accordance with at least one embodiment;

FIG. 4 illustrates another process for operating the system and training the AI model of the computing system in accordance with at least one embodiment;

FIGS. 5A, 5B and 5C illustrate screenshots of a graphical user interface of the computing system at different times in accordance with at least one embodiment;

FIG. 6 illustrates a flow chart of a method executed by the computing system in accordance with at least one embodiment;

FIG. 7 illustrates a flow chart of another method executed by the computing system in accordance with at least one embodiment; and

FIG. 8 illustrates a data flow for AI-based reporting integrated into the computing system in accordance with at least one embodiment.

### DETAILED DESCRIPTION

In the fast-paced realm of modern dining establishments, efficiently managing kitchen order preparation and table turn time is paramount. Existing methods often rely on manual handling of orders in the kitchen or simply prioritizing orders based on delivery couriers, overlooking dynamic factors affecting preparation time, table turn time, and order prioritization. This can lead to increased wait times, inefficient resource utilization, and diminished customer satisfaction.

The described system and method address these challenges by leveraging machine learning and artificial intelligence to optimize kitchen workflows and table turn time, specifically tailored for environments such as dine-in hotel restaurants or fine dining establishments. Many existing systems focus solely on delivery prioritization, sometimes based on a first-come-first-serve basis. In some cases, the described system considers a comprehensive array of factors such as order preparation time, complexity of the order, resources, staff involvement, customer loyalty, feedback or complaints, and predicting order volume using machine learning algorithms.

In some cases, the described system is a computing system for dynamically controlling the preparation of kitchen order food preparation using machine learning, and processing input data. In some cases, the input data includes table turn time, in-progress food item preparation status, preparation time for a food item, order size, kitchen equipment availability, staff availability, weather, and traffic. Other inputs may include delivery personnel availability, promise time for fulfilling the order, customer satisfaction rating, distance to deliver an order, kitchen order backlog, customer profile and allergies, and customer loyalty data. In some cases, the computing system predicts order volume using machine learning.

In some cases, the computing system controls the sequence the food order preparation, to reduce wait times, reduce table turn time, and reduce idle periods, thereby enhancing overall efficiency and customer satisfaction.

In some cases, the computing system utilizes machine learning techniques to train models for order prioritization and assignment. An artificial intelligence (AI) model is trained on historical data to learn complex patterns and optimize decision-making processes in real-time. The terms “AI model” and “ML model”, where ML means machine learning, are herein used interchangeably. In some cases, the AI model is continuously retrained using recent incoming order data and recent performance data of a kitchen establishment.

In some cases, the computing system improves operational efficiency of a kitchen establishment by reducing idle time, reducing delivery delays, and increasing resource utilization. In some cases, the computing system adds routing algorithms, which affects order assignment or prioritization and driver dispatching in a dynamic environment. In a more general aspect, the computing system improves food order preparation coordination, including the prioritization of food orders to be cooked or placed on shelf based upon various parameters. In some cases, the computing system improves the assignment of food orders to delivery personnel or delivery vehicles.

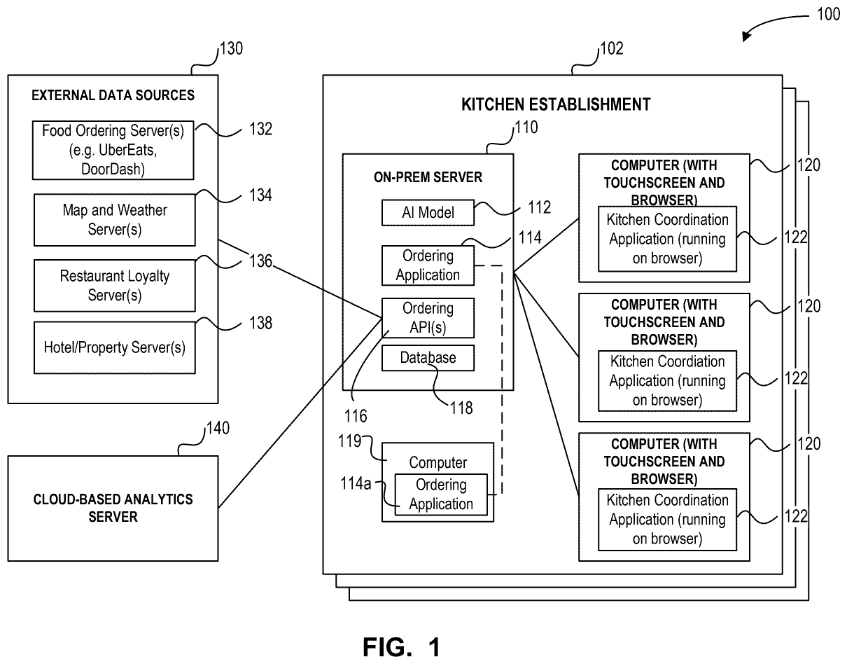

Referring to FIG. 1, an exemplary computing system architecture for a computing system in accordance with at least one embodiment. The computing system is generally identified by reference character 100. The computing system 100 includes an on-premises (“on-prem”) server 110 hosting several modules such as, for example, an artificial intelligence (“AI”) model 112, an ordering application 114, one or more ordering application programming interface (“API”) 116, and a local database 118. The on-prem server 110 is situated within the premise of a kitchen establishment 102. The on-prem server 110 is operationally connected to one or more computers 120 (also called on-premise computing devices) in the kitchen establishment 102. The one or more on-premise computing devices 120 include a web browser, and may include touchscreen capability. In some cases, the on-premise computing device 120 is an integrated housing that includes a touchscreen display, processor, memory, and communication interface. In some cases, the on-premise computing devices 120 are also called on-premise display devices. The one or more on-premise computing devices 120 include a kitchen coordination application (“KCA”) 122 that, in some cases, runs on the browser. The kitchen coordination application 122 includes a graphical user interface (GUI) for interacting with personnel of a given kitchen establishment. External data sources 130 are operatively connected to the on-prem server 110. The external data sources 130 include, for example, food ordering servers 132, map and weather servers 134, and a restaurant loyalty server 136. A cloud-based analytics server 140 is operatively coupled to the on-prem server 110.

In some cases, the on-prem server 110 is a controller that controls the one or more on-premise computing devices 120. The on-prem server 110 receives real-time input data from external data sources (e.g., external to the kitchen establishment) and real-time data from local data sources (e.g., computer 119, one or more on-premise computing devices 120, network enabled kitchen equipment, etc.) to dynamically control outputs at the one or more on-premise computing devices 120. In some cases, the controller physically (e.g., digitally) converts the inputs to a discernible output that is transmitted and displayed at the one or more on-premise computing devices 120.

In some cases, the modules, features and operations executed by the on-prem server 110 facilitate faster processing of information, when data inputs are provided locally at the kitchen establishment 102. In some cases, the modules, features and operations executed by the on-prem server 110 reduce “down time” or periods of time when the computing system is not operable for the kitchen establishment. For example, in some cases when the Internet may be disconnected (e.g., for Internet outages), the on-prem server 110 remains operable to control the kitchen preparation activities.

In some other cases, the features and operations executed by the on-prem server 110 as described herein are alternatively executed in a cloud server that is external to the kitchen establishment 102. In other words, the cloud server includes the AI model 112, the ordering application 114, the ordering API(s) 116, and the database 118.

In some cases, the kitchen establishment 102 is a restaurant that can accommodate dine-in customers, take-away customers, and customers requesting delivery. The term “take-away” is also called “take-out”, referring to customers that go to the kitchen establishment to take away or take out their food order. In some cases, the kitchen establishment 102 may accommodate only dine-in customers. In some cases, the kitchen establishment 102 may accommodate dine-in customers and take-away customers. In some cases, the kitchen establishment 102 may accommodate take-away customers and customers requesting delivery. The kitchen establishment 102 prepares food items in response to receiving food orders. The food orders may be received in person from dine-in customers. The food orders may be received in person from take away customers. The food orders may be received remotely (e.g., via telephone or through an online ordering system, or both) from take away customers or customers requesting delivery, or requesting take-away. In some cases, the kitchen establishment also fulfill drive through orders (also called drive-thru orders). In some cases, drive through orders are received by a staff member and entered into a computer 119, which is located at the kitchen establishment 102, and transmitted to the on-prem server 110. In some other cases, drive through orders are received by an online ordering system and transmitted to the on-prem server 110. Food orders received at the kitchen establishment 102 from dine-in customers and take away customers are entered to the on-prem server 110 via the ordering application 114. In some cases, the computing system 100 accommodates the various types of operations of a kitchen establishment 102.

In some cases, each food order is associated with an order type that is tracked by the on-prem server 110. In some cases, the order type is selected from a group comprising a dine-in type, a delivery type, and a take-away type. In some cases, the group also includes a drive through type.

The kitchen establishment 102 includes a kitchen for preparing food orders. In some cases, the kitchen establishment 102 is a building that includes equipment and food ingredients for preparing food, and personnel (e.g., cooks, chefs, food attendants, supervisors, and/or managers) work in the kitchen establishment. Delivery workers and/or delivery vehicles (e.g., including manually operated vehicles, semi-autonomous vehicles and autonomous vehicles) travel to and from the kitchen establishment 102 to pick up and deliver food orders. In some cases, the equipment for preparing food includes an oven, a mixer or blender, a grill, and a deep fryer. Other types of food preparation equipment could be used in the kitchen establishment. In some cases, the equipment is labeled as Station 1, Station 2, Station 3, etc., or the like, whereby each station is representative of a cooking or food preparation area within the kitchen. In some cases, different stations are assigned different functions, such as grill station, fry station, drink station, etc.

The on-prem server 110 is located at the kitchen establishment 102. The on-prem server 110 is configured to receive food orders from the food ordering servers 132 and from the ordering application 114. Food orders received from the food ordering servers 132 are received at the on-prem server 110 through the one or more ordering APIs 116 and may be food orders for take-away customers or food orders for customers requesting delivery. Food orders received through the ordering application 114 are input at the kitchen establishment 102. The food orders that are input to the ordering application 114 may be entered by staff or by customers. In some cases, the ordering application 114 is accessible or indirectly accessible to staff via a computer 119 which includes an instance of the ordering application 114a, or is a web browser that displays an instance of the ordering application 114a. The instance of the ordering application 114a on the computer 119 communicates with the ordering application 114. In some cases, the computer 119 is a handheld device, such as a tablet or smartphone, or similar. In some other cases, the computer 119 is a desktop computer. Staff may enter food orders from customers (e.g., dine-in customers, take away customers, drive through customers, delivery customers, etc.) into the ordering application 114a. In some cases, the staff select an order type when entering in a food order. In some cases, the computer 119 is a self-service computing kiosk where dine-in customers or take away customers may enter food orders into the instance of the ordering application 114a themselves. In some cases, the customer selects an order type when entering their food order into the ordering application 114a. Other computing devices that facilitate entry of food orders by the staff of the kitchen establishment or by the customers themselves are applicable to the principles described herein. In some cases, the computer 119 is called a Point-of-Sale (POS) device.

In some cases, the AI model 112 is configured to generate a sequenced list for the food orders received by the on-prem server 110. The AI model 112 analyses the food orders and assesses them alongside data pulled from the local database 118 to create the sequenced list. The sequenced list is provided to the kitchen coordination application 122 on the one or more on-premise computing devices 120 for kitchen staff to view the order in which the food orders are to be prepared. The AI model 112 determines the sequence in which the food orders are to be prepared and in the case of food orders for delivery, the sequence in which the food orders are delivered.

The ordering application 114 facilitates the entry of orders to the system 100 from staff and customers at the kitchen establishment 102. The information entered into the ordering application 114 may include, for example, the order type, the food items for the order, customer information, and special requirements etc. The customer information includes, for example, customer name, contact details, address. Special requirements include, for example, customization of the food orders, allergy information, and dietary requirements.

The one or more ordering APIs 116 are configured to receive information to the system 100 from the external data sources 130 and the cloud-based analytics server 140. In some cases, there are one or more ordering APIs that communicate with one or more food ordering servers 132. In some cases, there are one or more ordering APIs that communicate with the map and weather servers 134. In some cases, there are one or more ordering APIs that communicate with the one or more restaurant loyalty servers 136. The data ingested via the one or more ordering APIs are processed by the on-prem server 110, and, in some cases, are inputted into the AI model 112.

In some cases, the one or more food ordering servers 132 send food orders to the on-prem server 110 via the one or more ordering API 116. The food orders from the food ordering servers 132 are input by customers requesting delivery or take out orders. These food orders are received along with customer information, and special requirements etc.

The local database 118 may be a local to and hosted by the on-prem server 110. In some cases, the database 118 maybe be hosted on a separate server. The database 118 is configured to store kitchen staff status data and kitchen equipment status data. The kitchen staff status data includes for example, availability of kitchen staff and the number of kitchen staff available. The kitchen equipment status data includes for example, the number of each kitchen appliance available, whether any kitchen appliances are unavailable due to maintenance, an estimate of when kitchen appliances will be made available. The kitchen staff status data and kitchen equipment status data may be updated manually by staff. In some cases, the database 118 also stores: average or estimated preparation times for a given food item; or a complexity description or rating for preparing a given food item; or preference scores for dine-in orders, take-out orders and/or delivery orders; a list of VIP customers; or a combination thereof.

The external data sources 130 are operably connected to the on-prem server 110 via the one or more ordering APIs 116. The one or more food ordering servers 132 are configured to allow customers requesting delivery to select food items and submit a food order through an ordering application of choice (e.g., third-party ordering platforms available under the tradenames Uber Eats, Door Dash, etc.) which is sent to the on-prem server 110 via the one or more ordering APIs 116.

In some cases, the map and weather server 134 is a single server providing information relating to weather conditions and traffic conditions or, in some other cases, there are multiple map and weather servers providing this information. The map and weather server 134 provides the information relating to weather conditions and traffic conditions to the on-prem server 110 via the one or more ordering APIs 116. The AI model 112 uses the information received from the map and weather server 134 in determining the sequence in which food orders are to be delivered. The AI model 112 processes the information received from the map and weather server 134 in determining the routes used for delivering the food orders.

The restaurant loyalty server 136 provides customer loyalty information to the on-prem server 110 via the one or more ordering API 116. The AI model 112 uses this information to prioritize food orders based on customer loyalty. Customer loyalty information includes, for example, how many times a customer has ordered from the kitchen establishment 102, how many times a customer has ordered a particular food item, a VIP status that a customer has etc. The restaurant loyalty server 136 may facilitate the gathering of customer feedback for the kitchen establishment 102 and food items. In some cases, there is also a hotel property management server 138 that provides data to the on-prem server 110. In some cases, such a server is available under the tradename Opera. The hotel property management system contains hotel customer's check in and check out information, customer profiles and notes, and customer loyalty status. In some cases, the restaurant loyalty server or the hotel property management server, or some other data source, includes user profile information, including food preferences and allergies.

While the FIG. 1 shows data from external data sources 130 being ingested by the on-prem server via one or more ordering APIs 116, in some other cases, the data from external data sources 130 are transmitted and received by the on-prem server 110 via other currently known and future known communication protocols and modules.

The cloud-based analytics server 140 is configured to receive information from the on-prem server 110. The on-prem server 110 periodically sends information to the cloud-based analytics server 140 for analysis. The on-prem server 110 may send information daily, weekly, bi-monthly, monthly, quarterly etc. The cloud-based analytics server 140 analyses the received information at the intervals in which it is received, and is configured to send a report to the on-prem server 110. Staff at the kitchen establishment 102 can review the report and adjust practices accordingly e.g., frequency of ordering ingredients, quantity of ingredients orders, frequency of ordering packing, volume of packaging ordered.

In some cases, the on-prem server 110, using its AI model, detects low supplies, low ingredient inventory, and forecasts inventory amounts. In some cases, the on-prem server 110, using its AI model, send alerts for ordering resupply. In some cases, these functions are executed by the cloud-based analytics server 140.

In operation, the system 100 a plurality of food orders. The plurality of food orders is received via the ordering application 114 from kitchen establishment staff or in-person customers, or via the one or more ordering APIs 116 from one or more online food ordering servers 132, or both.

The on-prem server 110 extracts information from each food order. The information extracted from each food order includes the customer name, the customer address, a food dataset which identifies one or more subset food items, and a timestamp indicating the time at which the food order was placed. Each food order and the extracted information may be stored in the database 118. The database 118 stores the food orders. After a configurable length of time, the database 118 may archive food orders.

Each food order may be for a single food item (e.g., dish) or for more than one food item (e.g., dishes). The food dataset for each food item includes the one or more subset food items. The one or more subset food items includes ingredients required to prepare the food item or food items in the food order. The database 118 stores information regarding ingredients for each food item available for order. For example, the database 118 includes an inventory of available ingredients. The database 118 stores information regarding the preparation of each food item available for order including, for example, preparation steps and associated preparation times for each preparation step and required kitchen equipment for the preparation steps.

The on-prem server 110 transmits some of the information to the external data sources 130. In some cases, the on-prem server 110 transmits the customer address for each food order and the address of the kitchen establishment 102 to the map and weather servers 134 and, in response, the on-prem server 110 receives an estimated delivery time and weather conditions from the map and weather server 134 for each food order. The on-prem server 110 interfaces with the map and weather server 134 via the one or more ordering APIs 116 for sending and receiving the information.

The on-prem server 110 accesses the database 118 to obtain information regarding kitchen resources. In some cases, the information regarding the kitchen resources includes the current availability of kitchen staff, the current availability of ingredients and/or materials, and the current availability of kitchen equipment required for the preparation of the one or more subset food items in each food order. In some cases, the availability of kitchen staff corresponds to a staff schedule that can be manually entered by restaurant management. In some cases, the availability of kitchen equipment corresponds to a maintenance status of appliances. In some cases, the availability of kitchen equipment affects the amount of time a respective piece of kitchen equipment is allocated to preparation of food items, or when the respective piece of kitchen equipment is allocated to preparation of food items, or both.

In some cases, a customer loyalty status that is associated with the customer name is extracted. In some cases, the customer loyalty status is extracted from the restaurant loyalty server 136 by the on-prem server 110 via the one or more ordering API 116. If the customer loyalty status indicates a high loyalty status (i.e., a VIP status), a customization rule may be applied that specifies prioritizing a food order from a customer with a high loyalty status. The customization rule and the customer loyalty status associated with the customer name are provided to the trained AI model 322. The customization rule may be manually set in the system 100 by restaurant management to reflect preferred prioritization of VIP customers.

The collected information for each food order is provided to the AI model 112. In some cases, the information provided to the AI model 112 includes, for each food order: the order type (e.g., dine-in, take-away, delivery, drive through, etc.) the customer name, the customer address, the food dataset identifying the one or more subset food items, the timestamp, the delivery time, the weather conditions, the current availability of kitchen staff and the availability of the kitchen equipment. In some cases, other data inputs entered into the AI model 112 include: the number of orders pending, the number and type of courses for dine-in customers, the status of the course that is active for dine-in customers (e.g., appetizer (active?); main (active?); dessert (active?)), and inventory.

In some cases, AI model architecture and processing, including varied types of input processed, provides outputs transmitted to and displayed at the one or more on-premise computing devices 120, which are lead to more time efficient cooking operations at the kitchen establishment 102. In some cases, efficiency metrics include a wait time (e.g., time elapsed) between when a customer places a food order and when the customer to receive their food; a wait time (e.g., time elapsed) between when a customer is expected to receive their food (e.g., which may be at a later time after the customer places their food order) and when the customer receives their food; an expected temperature (e.g., perceived temperature satisfaction) of the food at receipt by the customer; and a time to prepare a food order. It will be appreciated that other efficiency metrics may be tracked.

The AI model 112 determines a sequenced list for the plurality of food orders. A first subset of the plurality of food orders in the sequenced list is labelled as “active” indicating that these food orders are to be prepared and cooked (also herein called a cook status). A second subset of the plurality of food orders in the sequenced list is labelled as “on hold” indicating that these food orders are not to be prepared or cooked yet (also herein called a hold status). Each food order in the second subset of the sequenced list is provided with a reason for the “on hold” label in a text format. The AI model 112 determines the holding reason. In some cases, the holding reason includes, for example, waiting for a specific ingredient, or a higher priority food order takes precedence, or a kitchen resource constraint, or a combination thereof.

When a new food order is received, the AI model 112 is re-executed. Information from the new food order and the second subset of the plurality of food orders in the sequenced list (which is the set of food orders “on hold”) is used by the AI model 112 to compute a new sequenced list. The new sequenced list includes the new food order. The new food order is labelled as either an “active” food order or an “on hold” food order. This controller configuration at the on-prem server 110 is dynamic to the new inputs received, and facilitates new real-time (or near real-time) outputs at the one or more on-premise computing devices 120 that are responsive to the new inputs.

In some cases, each food order of the plurality of food orders in the second subset in the sequenced list has an estimated release time for when the “on hold” status will transition to the “active” or cook status. The AI model 112 computes the estimated release time. This may be based on the estimated preparation time of the currently active food orders.

The first subset of the plurality of food orders includes a first food item that is part of a given food order and the second subset of the plurality of food orders includes a second food item that is part of the same given food order. In some cases, the first food item may be associated with a first preparation time x and the second food item may be associated with a second preparation time y that is less than the first preparation time x. The on-prem server (e.g., via its AI model 112) may automatically transition the “on-hold” status of the second food item to the “active” or cook status approximately (x-y) minutes after receiving an indication that the first food item has started being prepared. The indication may be provided via a manual input to the kitchen coordination application 122 by kitchen staff confirming preparation has commenced.

The first subset of the plurality of food orders is sent to the one or more on-premise computing devices 120 for display at the kitchen coordination application 122. Kitchen staff are able to view and interact with the kitchen coordination application 122 on the one or more on-premise computing devices 120.

In some cases, the kitchen coordination application 122 facilitates manually overriding food orders. For example, using the GUI of the kitchen coordination application, a kitchen staff can input a manual override to modify a food order with a cook status to a hold status, and/or modify a food order with a hold status to a cook status. In turn, this manual update is automatically inputted into the model AI and recalculates the impact on the given food order that has been modified and the other food orders that have a cook status and the other food orders that have a on hold status. In some cases, the sequence of priority of food orders with a hold status (e.g., on hold status) may be reordered as a result of the manual modification.

In some cases, a manager or supervisor at the kitchen establishment can go to any on-premise computing device 120 to input a manager code, and override a current status on an order (e.g., modify a cook status to a hold status, or vice versa), and the order's status update automatically cascades to the other on-premise computing devices 120.

In some cases, for each food order, the on-prem server executes the following operations: extract a customer name, a customer address, a food dataset identifying one or more subset food items, and a timestamp associated with the food order; transmit the customer address and a kitchen address, which are receivable by the external mapping system, and receive a delivery time and a weather condition associated with a delivery of the food order, which are transmittable by the external mapping system; access the local database to retrieve a current availability of a kitchen staff member and a current availability of a kitchen equipment associated with preparation of the one or more subset food items; and input the customer name, the customer address, the food dataset identifying the one or more subset food items, the timestamp associated with the food order, the delivery time, the weather condition, the current availability of the kitchen staff member and the current availability of the kitchen equipment into the AI model.

After the data has been inputted into the AI model, the on-prem server computes, using the AI model, a sequenced list of the plurality of food orders, wherein a first subset of the plurality of food orders in the sequenced list is associated with a cook status and a second subset of the plurality of food orders in the sequenced list is associated with a hold status.

In some cases, each one of the plurality of food orders in the second subset in the sequenced list is further associated with a holding reason in a text format, and wherein the ML model computes the holding reason. In some cases, the holding reason is displayed with the associated food order in the GUI of the kitchen coordination application. This provides context to the kitchen staff. In some cases, the holding reason is in natural language and is generated ad hoc by the AI model. In some cases, the holding reason is selected from amongst a predetermined list of holding reasons.

In some cases, the on-prem server then transmits at least the first subset of the plurality of food orders in the sequenced list (e.g., food orders associated with the cook status) to the plurality of on-premise computing devices.

In some cases, when a new food order is received by the on-prem server, the on-prem server re-executes the AI model using the new food order and at least the second subset of the plurality of food orders in the sequenced list to compute a new sequenced list. The new sequenced list includes the new food order that is associated with the cook status or the hold status.

The food orders displayed at the kitchen coordination application 122 may be sorted based on the order time or timestamp which indicates the time at which the order was made, or based on the “required time” which indicates when the customer requires the order. This is a configurable setting in the system 100.

In some cases, the AI model 112 determines a food order volume forecast with a predictive machine learning model. In some cases, the AI model 112 executes the predictive machine learning model to further compute a pattern associated with the food order volume forecast.

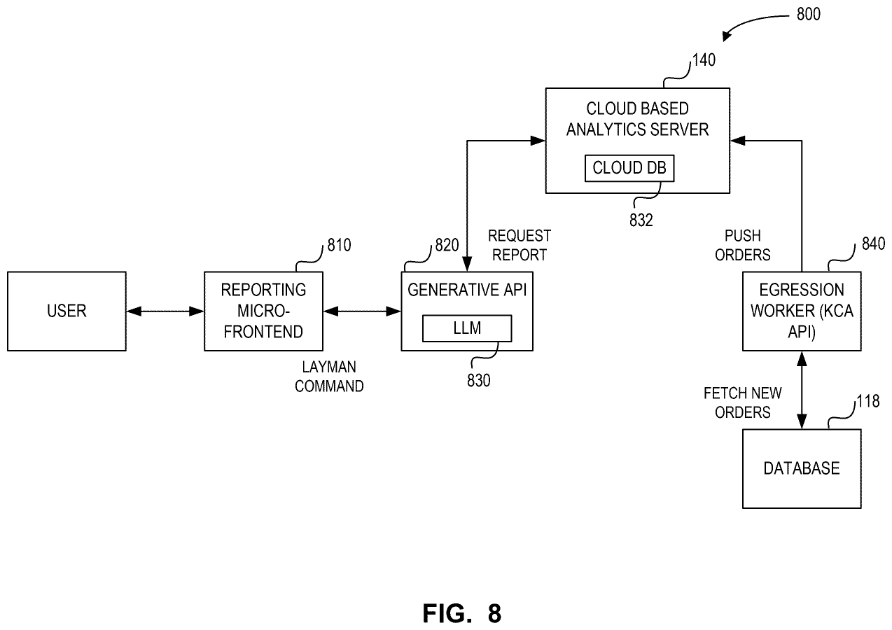

Referring now to FIG. 8, there is illustrated an example architecture for reporting based on generative AI. The example architecture is generally identified as reference character 800. The example architecture 800 may be implemented, for example, by the cloud-based analytics server 140. The architecture 800 includes, for example, a reporting micro-frontend module 810, a generative API 820, an egression worker 840 accessible by the kitchen coordination application 122. The generative API 820 and the kitchen coordination application 822 are operatively connected to a cloud based analytics server 140. The reporting micro-frontend module 810 is operatively connected to the generative API 820. The egression worker 840 is operatively connected to the database 118. In some cases, different instances of kitchen establishments 102 (e.g., from the same company and/or from different companies) are configured so that their respective on-prem servers 110 send data from their respective databases 118 to one or more egression worker 840, which in turn push the data from these different instances of kitchen establishments to the cloud-based analytics server 140. In other words, the cloud-based analytics server is able to aggregate data from various kitchen establishments.

The reporting micro-frontend module 810 is configured to provide a chat interface for a user to interact with. The reporting micro-frontend module 810 is configured to send inputs from the user to the generative API 820. The user may input queries to the reporting micro-frontend module 810. The queries may be input to the reporting micro-frontend module 810 in natural language, i.e. as a layman command. For example, the user can input natural language queries into the chat interface, such as:
Show me days that had 5% fewer orders, and explain why; or
Show me days when deliveries were 10 minutes late, and explain why.
   These natural language queries or layman commands are sent from the reporting micro-frontend module 810 to the generative API 820. The generative API 820 includes a large language model (LLM) 830 that processes the layman commands (also called natural language queries) into queries, or requests, to probe the cloud based analytics server 140 for report data. The queries or requests are in a data format that is understood and processable by the cloud-based analytics server 140; these queries are also herein called data-formatted queries. In some cases, the cloud-based analytics server 140 is a SQL server and the queries or requests are in a SQL format. In some cases, cloud-based analytics server 140 includes a cloud database 832 that is a structured database (e.g., a columnar database). The data-formatted queries are configured to extract all the related data (e.g., ingredients of the order, food equipment used, staff personnel making the order, delivery driver, traffic conditions, weather conditions, etc.) that may be relevant to the query.

In some cases, the cloud database 832 is considered a backend database probed by the generative API 820. The cloud database 832 is populated by historical order data from one or more instances of databases 118 located at one or more kitchen establishments 102. In some cases, an egression worker 840 (e.g., an automated computing agent in the cloud computing environment) pulls new order data from the kitchen establishment 102 and/or other kitchen establishments and pushes the order data to populate the cloud database 832. This process of fetching the order data from the on-prem databases 118 and populating the cloud database 732 could occur on a periodic basis, or in near real-time, or on an adhoc basis.

In some cases, the flow of data from an egression worker 840 to the cloud-based analytics server 140 is one directional. In some cases, data from the cloud-based analytics server 140 does not flow to the egression worker 840 in order to prevent transmission of potentially sensitive data from other kitchen establishments that may be stored on the cloud-based analytics server 140 to the egression worker.

In some other cases, data flows from the cloud-based analytics server to an egression worker or to an on-prem server, or both, to provide analytics data or reporting that is relevant to the respective kitchen establishment of the egression worker and/or on prem-server.

The request report is used to analyze and extract relevant information from the cloud database 832. The generative AI processes the data from the cloud database 832 to address the query. The generative AI identifies reasons that may have attributed to the fewer orders or lateness of delivery. For example: not enough ingredients, equipment malfunction or breakage, slower cooking time, inclement weather that caused traffic issues, etc.

The data and reasons are presented to the user at the reporting micro-frontend module 810 via the chat interface. The user may see details such as: reduced kitchen speed, driver not available, more orders than expected, and deviation by user compare to system suggestions as potential reasons once data for the query has been analyzed.

Typically, in any organization, questions such as the examples provided are asked by a management team to identify bottlenecks, inefficiencies, or what worked well. Real-time data analytics, powered by machine learning and automation, can offer powerful solutions. By identifying the root causes of inefficiencies (e.g., weather-related delays or a mismatch between expected and actual orders), organizations can make better-informed decisions.

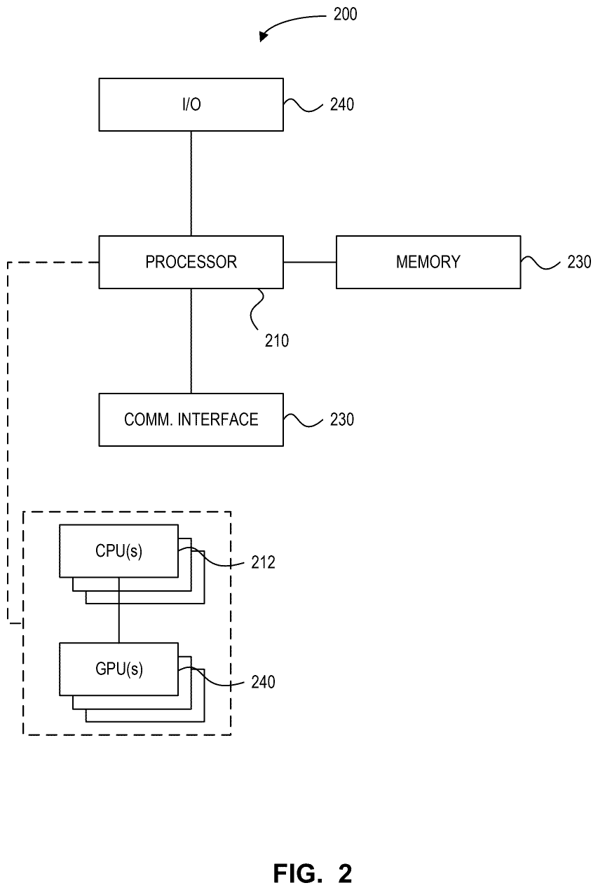

Referring now to FIG. 2, there is illustrated a simplified block diagram of a computer 200 in accordance with at least some embodiments. The computer 200 is also herein interchangeably called a computing system. Computer 200 is an example implementation of a computer such as the on-prem server 110, the on-premise computing devices 120, the computer 119, and the cloud-based analytics server 140 of FIG. 1. Computer 200 has at least one processor 210 operatively coupled to at least one memory 220, at least one communications interface 230 (also herein called a network interface), and at least one input/output device 240.

The at least one memory 220 includes a volatile memory that stores instructions executed or executable by processor 210, and input and output data used or generated during execution of the instructions. Memory 220 may also include non-volatile memory used to store input and/or output data—e.g., within a database—along with program code containing executable instructions.

Processor 210 may transmit or receive data via communications interface 230, and may also transmit or receive data via any additional input/output device 240 as appropriate.

In some cases, the processor 210 includes a system of central processing units (CPUs) 212. In some other cases, the processor includes a system of one or more CPUs and one or more Graphical Processing Units (GPUs) 214 that are coupled together. For example, the AI model executes neural network computations on CPU and GPU hardware, such as the system of CPUs 212 and GPUs 214.

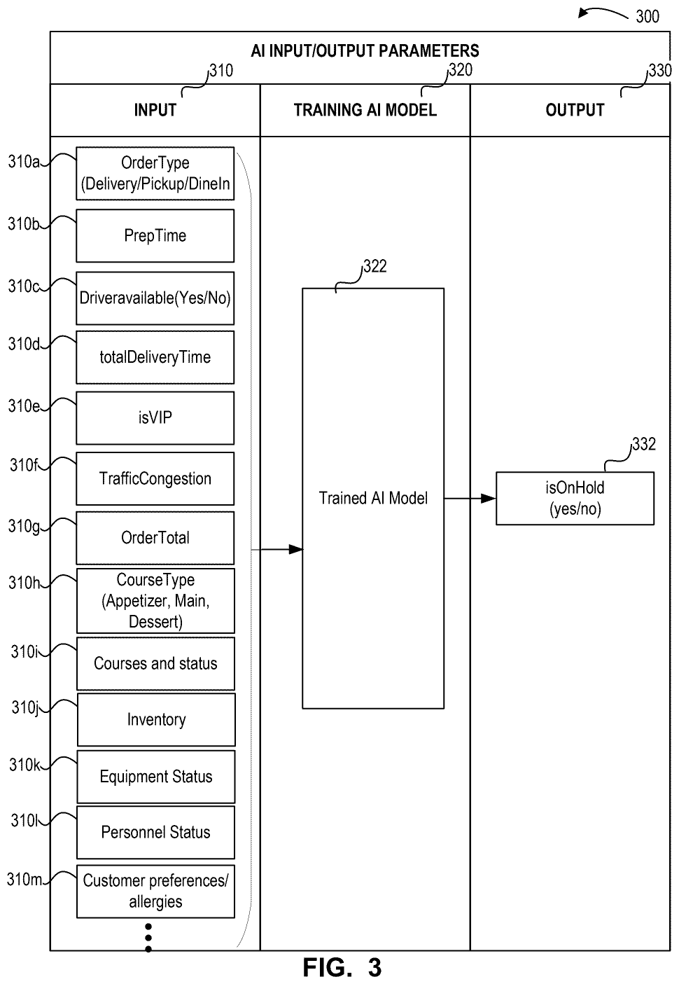

Referring now to FIG. 3 an exemplary process flow for training the AI model 112 is shown. In some cases, the AI model 112 is trained and developed using the ML.NET framework, such as AutoML.NET by Microsoft. The exemplary process is generally identified by reference character 300. The process 300 for training the AI model 112 includes data collection, feature engineering, kitchen resources, and customer feedback. Data collection includes obtaining information from the database 118, including order types (e.g., a dine-in type, a delivery type, and a take-away type), timestamps, order items, customer details, special requests, and promised delivery times. Environmental factors are taken into account as they may impact delivery of food orders for that are to be delivered. External data is obtained from the external data sources 130 that relates to weather conditions, traffic congestion, and special events. The availability of kitchen resources is taken into account. This includes data relating to available kitchen equipment and staff, as well as manual inputs from restaurant management. Customer feedback, including information on customer satisfaction, complaints, and preferences is gathered and also used to train the AI model.

The AI model 112 is trained based on information stored in the database 118. In some cases, the data input to the AI model 112 for training may be in a Comma-separated Value (CSV) format. The data is split to provide data for training the AI model 112 and data for testing the AI model 112 once it is trained.

In some cases, CSV files are loaded into AutoML.NET. In AutoML.NET, CSV files are converted into IDataView, which is the data format used for handling data in ML.NET.

The process 300 considers feature engineering or data processing. The on-prem server 110 may manipulate the raw data received in the food orders, from the external data sources 130, or from the database 118. The feature engineering considers order characteristics, operational metrics, and environmental impacts. Order characteristics relate to order type, order size, value, service level agreement requirements, and whether the customer is a VIP. Operational metrics relate to calculation of preparation times, wait times, table turn times, and order aging. Environment impacts relate to assessment of how external factors like weather and traffic impact order prioritization.

The AI model 112 is trained based on the data collection and feature engineering data. The data is preprocessed before being provided to the AI model 112 for training. The preprocessing includes cleaning the data to handle duplicates, missing values, and ensure data consistency. Machine learning algorithms are used to predict order volumes and demand patterns based on the engineered features and collected data. The AI model 112 is trained using the historical data, optimizing for minimizing wait times, reducing idle periods, and enhancing overall kitchen efficiency and customer satisfaction.

The process 300 includes an input 310, training 320 of the AI model 112, and an output 330. The input 310 includes several categories 310a-310g: order type 310a, preparation time 310b, driver availability 310c, delivery time 310d, VIP indicator 310e, traffic congestion information 310f, and order total 310g. The output 330 includes an order status 332 for the received food order. The AI model 112 is trained using historical food orders stored in the database 118. The input 310 to the process 300 includes data relating to specific orders and feature engineering of the AI model 112.

The input 310 corresponds to a data collection portion of the process 300. Historical data relating to orders is extracted from the database 118. This information relates to the order type 310a, timestamps, order items, customer information, special requests, and promised delivery times. The order type 310a identifies if the food order in a dine-in order, a take away order, an order for delivery, or for an order for drive-through. The timestamps identify when the food order was received. The order items are the food items within the order e.g., individual dishes ordered. The customer details include customer name, address, contact information, payment details etc. The special requests include any customizations allowed for the individual dishes ordered, or any allergy or dietary information of the customer that results in a modification to the individual dishes. The promised delivery times are the set service standards for the kitchen establishment 102. Individual dishes may have differing promised delivery time depending on whether they are hot dishes or cold dishes.

The input 310 includes preparation time information 310b. The preparation time information 310b is the length of time required to prepare a food item. Each food order can be for a single food item (e.g., dish) or for more than one food item (e.g., dishes). The AI model 112 calculates the preparation time for a food order based on the preparation time information 310b.

When the order type 310a is for a delivery order, the input 310 includes a driver availability indicator 310c. The driver availability indicator 310c indicates if there is a delivery driver available to deliver the food order. The input 310 includes total delivery time information 310d. The total delivery time information 310d is the length of time required to deliver the food order. The total delivery time information 310d is obtained from the maps and weather servers 134 which determine the route between the kitchen establishment 102 and the customer's address for the food order.

The input 310 includes a VIP indicator 310e. The VIP indicator 310e identifies the customer associated with a food order as a VIP. The system 100 uses this information to prioritize orders. The VIP indicator 310e is obtained from the restaurant loyalty server 136 by the on-prem server 110.

The input 310 includes traffic congestion information 310f. The traffic congestion information 310f identifies any traffic issues on the delivery route for the food order. Traffic congestion information 310f can include traffic volume, traffic accidents, road closures etc. The traffic congestion information 310f is obtained from the from the map and weather servers 134 identifying any issues affecting the route.

The input 310 includes an order total 310g. The order total 310g is the total price for the food order.

In some cases, the input includes a course type 310h, which is data identifying the different types of courses (e.g., appetizer, main, dessert). This is applicable to dine-in customers, which, in some cases, have a different effect on the prioritization of food orders compared to other order types. In some cases, data is associated with each course, such as an estimated consumption time, prioritization weighting, etc. In some cases, the appetizer course is associated with an estimated consumption time x, the main course is associated with an estimated consumption time y, and the dessert course is associated with an estimated consumption time z. In some cases, the appetizer course is associated with a prioritization weight w1, the main course is associated with a prioritization weight w2, and the dessert course is associated with a prioritization weight w3. In some cases, the prioritization weights have the relationship w1>w2>w3.

In some cases, the input includes courses and status data 310i, which is data identifying which course a certain dine-in customer has most recently been served. For example, the system knows that if the customer has not been served their appetizer course, then the next course to be served to the customer is the appetizer; and/or if the customer has been last served their appetizer course, then the next course to be served to the customer is the main course; and/or if the customer has been last served their main course, then the next course to be served to the customer is the dessert course.

In some cases, the input includes inventory data 310j, which includes available food supplies and other types of supplies at the kitchen establishment.

In some cases, the input includes equipment status data 310k, which includes availability of cooking stations, cooking machinery, etc.

In some cases, the input includes personnel status data 310l, which includes availability and roles of personnel working in the kitchen establishment (e.g., chefs, cooks, waiters, etc.).

In some cases, the input includes customer preference data 310m, which includes preferences and/or allergies.

In some other cases, other data components are included in the input 310.

The data obtained for the input 310 is preprocessed before being provided to the AI model 112 for training. This includes removing duplication entries, addressing holes in the data, and ensuring consistency across the data obtained. Any required calculations are performed, for example calculation of preparation times for the food order or the impact of weather or traffic conditions on the delivery time. The AI model 112 is then trained, providing a trained AI model 322. The trained AI model 322 determines the order in which food orders are prepared and delivered. The output of the trained AI model 322 includes the order status 332 which indicates whether the food order is to be prepared (“active”), or if it is placed on hold. The sequence in which the food orders are to be prepared, and the order status 332 for each food order are displayed at the one or more on-premise computing devices 120 via the kitchen coordination application 122. In some cases, the AI model is trained to compute (e.g., predict) a binary classification (e.g., “active” or “on hold”) of food orders in an ordered list (e.g., from highest priority to lowest priority).

The trained AI model 322 is validated against a separate dataset to evaluate performance. Metrics such as prediction accuracy, order prioritization efficiency, and customer satisfaction improvement are assessed. Real-time feedback from kitchen staff and customers is continuously integrated to refine and improve the trained AI model's 322 predictions and prioritizations.

The computing system 100 dynamically adjusts order prioritization based on real-time data from the kitchen coordination application 122. In some case, restaurant owners can define custom prioritization rules to align with their specific business goals and operational preferences.

In some cases, the training of the AI model occurs by using the following process: preparing the data, splitting the data into a training portion and into a validation portion, selecting the tasks, setting the model training pipeline, running training and validations of the AI model, and selecting and saving the trained AI model into the on-prem server.

In some cases, the AI model is retrained using new real-time data (or near real-time data). In other words, the AI model is dynamic and updated based on the most recent new data.

In some cases, Microsoft's ML.NET framework is used for AI model selection and training. In some cases, multiple models are trained using different algorithms and parameters, and one of the models is selected and deployed for real-time execution of incoming “live” data. Below is an example of training multiple models using different algorithms, such as logistic regression, decision tree and random forest. Other algorithms may be used according to the principle described herein.

In some cases, the on-prem server trains multiple AI models using different algorithms and hyperparameters. Below is an approach for training multiple models using different algorithms such as logistic regression, decision tree, and random forest.

```
using Microsoft.ML;
using Microsoft.ML.Data;
// Define your data classes
public class OrderData
{
  // Define your features here
}
public class OrderPrediction
{
  // Define prediction output here
}
class Program
{
  static void Main(string[ ] args)
  {
    // Create MLContext
    var mlContext = new MLContext( );
    // Load data
    IDataView dataView =
mlContext.Data.LoadFromTextFile<OrderData>(“path_to_data.csv”, separatorChar: ‘,’);
    // Split data into train and test sets
    var trainTestData = mlContext.Data.TrainTestSplit(dataView, testFraction: 0.2);
    var trainData = trainTestData.TrainSet;
    var testData = trainTestData.TestSet;
    // Define training pipeline for each model
    var logisticRegressionPipeline =
mlContext.BinaryClassification.Trainers.LbfgsLogisticRegression( );
    var decisionTreePipeline = mlContext.BinaryClassification.Trainers.DecisionTree( );
    var randomForestPipeline =
mlContext.BinaryClassification.Trainers.RandomForest( );
    // Train each model
    var logisticRegressionModel = logisticRegressionPipeline.Fit(trainData);
    var decisionTreeModel = decisionTreePipeline.Fit(trainData);
    var randomForestModel = randomForestPipeline.Fit(trainData);
    // Evaluate each model
    EvaluateModel(logisticRegressionModel, testData, mlContext);
    EvaluateModel(decisionTreeModel, testData, mlContext);
    EvaluateModel(randomForestModel, testData, mlContext);
  }
  static void EvaluateModel(ITransformer model, IDataView testData, MLContext
mlContext)
  {
    // Make predictions
    var predictions = model.Transform(testData);
    // Evaluate predictions
    var metrics = mlContext.BinaryClassification.Evaluate(predictions);
    // Print evaluation metrics
    Console.WriteLine($“Model Evaluation Metrics:”);
    Console.WriteLine($“ Accuracy: {metrics.Accuracy}”);
    Console.WriteLine($“ AUC: {metrics.AreaUnderRocCurve}”);
    // Add more metrics as needed
  }
}
```

The evaluation metrics of the different AI models are compared to select the AI model for deployment, for use in the on-prem server.

In some cases, after the AI model is initially trained and selected, the AI model is deployed for real-time predictions using live ingested order data and data about the states of the kitchen establishment (e.g., available and/or deployed kitchen personnel, available and/or deployed kitchen equipment, available and/or deployed ingredients, available and/or deployed delivery personnel). The real-time data input is used to make predictions about the food orders (e.g., a binary classification of on hold vs active food orders, and an ordered list of the on hold food orders). The process also includes collecting real-time feedback and recording the actual outcome of each prediction (e.g., includes whether the model was accurate or not and by what quantifiable error). For example, the feedback includes: actual vs. predicted values; or user interactions (e.g., whether a recommendation was followed or ignored); or, errors and/or discrepancies between the prediction and the actual outcome; or a combination thereof.

In some cases, the new data, along with the feedback, is continuously fed back into the computing system automatically on regular interval of times. Detecting the new data triggers the AI model to be retrained using the new data, thereby generating an updated AI model. The updated AI model replaces the previous version of the AI model.

In some cases, the AI model is trained to consider one or a combination of the following prioritization parameters (which may include rules) in determining food order prioritization: customizable order prioritization rules; order type and service level agreement (SLA); order size and revenue potential; order aging and stale order prevention; customer wait time tolerance; distance to customer location; order aggregation and consolidation; preferred delivery partners; delivery person or delivery vehicle location; driver or cook performance or availability; manual input(s); customer status; preparation times across kitchen establishment; preparation time estimates; promise time; environmental impact; real-time feedback loop integration; visual order complexity indicator; menu item popularity analytics data; predictive order volume forecasting data; table prioritization (for dine-in); order size and revenue potential (for dine-in); collaborative order annotations; and loyalty program data.

Customizable Order Prioritization Rules: These rules provide flexibility for owners and/or operators of a kitchen establishment to define custom order prioritization rules based on their specific preferences and business goals. These rules facilitate customization of prioritization criteria such as order size, order value, or customer loyalty status or all rules defined below. An interface for the ordering application 114 facilitates the operator to adjust or modify which rule has a higher priority for their kitchen establishment, or to define a sequence of rules for the system, or both.

Order Type and Service Level Agreement (SLA): In some cases, the AI model prioritizes orders based on their service level agreement (SLA) requirements. For example, delivery orders with guaranteed delivery times may need to be prioritized over dine-in or takeout orders to meet delivery commitments and minimize penalties.

Order Size and Revenue Potential: In some cases, the AI model prioritizes larger food orders or those with higher revenue potential. While smaller orders may be simpler to prepare, larger orders contribute more to the revenue of the kitchen establishment and may be prioritized accordingly. In some cases, the AI model considers the cost and the profitability of fulfilling each order when prioritizing. For example, the AI model prioritizes higher-profit margin food orders over lower-profit margin food orders.

Order Aging and Stale Order Prevention: In some cases, the AI model identifies and prioritizes food orders that have been waiting for an extended period to prevent order aging and ensure freshness. Stale orders can negatively impact customer satisfaction and should be addressed promptly.

Customer Wait Time Tolerance: In some cases, the AI model processes the customer's tolerance for wait times based on their chosen service type. For example, dine-in customers may be associated with a higher tolerance for wait times compared to delivery or takeout customers who expect faster service. In some cases, the tolerance is expressed over a range of values, representing low tolerance up to high tolerance. In some other cases, the tolerance is expressed as time values, whereby a high wait time tolerance is associated with a higher time value and a low wait time tolerance is associated with a time value lower than the higher time value.

Distance to Customer Location: In some cases, the AI model prioritizes delivery orders based on the proximity of the customer's location to the kitchen establishment. In some cases, food orders that are closer to the kitchen establishment are prepared and dispatched earlier (e.g., at a higher priority) to ensure timely delivery and customer satisfaction.

Order Aggregation and Consolidation: In some cases, the AI model consolidates multiple orders going to the same location or customer into a single batch for preparation and delivery. This reduces the number of trips and optimizes delivery routes, improving efficiency and reducing delivery times.

Preferred Delivery Partners: In some cases, the AI model prioritizes orders from preferred delivery partners with the kitchen establishment. These preferred delivery partners may offer faster delivery times, or higher order volumes, or better terms, making their orders more desirable to the kitchen establishment.

Delivery Person or Delivery Vehicle Location: In some cases, the AI model processes the location of the delivery person (or the delivery vehicle) and further processes traffic conditions and weather conditions for the predicted travel routes. In some cases, the AI model executes one or a combination of the following rules.

Rule 1: If a delivery personnel (or a delivery vehicle) has a predicted travel time to arrive at the kitchen establishment that matches (e.g., within a tolerance of +/−x minutes) the estimated preparation time for a food order, then classify the food order as active. In some cases, the tolerance of x minutes for matching is 1, 2, or 3 minutes, or is adjustable to some other time value. In an example, a food order has a preparation time of 10 minutes, and the AI model computes that the delivery personnel (or the delivery vehicle) will be at the kitchen establishment in less than or equal to 10 minutes; this this example, the AI model classifies the food order as active (e.g., for cooking), which is displayed in the GUI of the kitchen coordination application. In some cases, the kitchen coordination application in such a scenario is further configured to automatically display a message to place the completed food order on a shelf or pick-up location for the delivery personnel (or the delivery vehicle).

In some cases, the predicted travel time and/or arrival time of the delivery personnel (or the delivery vehicle) is periodically updated after computing an initial predicted travel time or arrival time, since weather and traffic conditions are subject to change over time. In this context, Rule 2 includes: If a delivery personnel is delayed beyond an initial predicted travel time, then output an alert via the kitchen coordination application to the kitchen personnel to prepare the food order by a delayed amount of time. For example, the food order preparation time is 5 minutes, and the initial predicted travel time for the delivery personnel is 5 minutes; and the AI model and the kitchen coordination application initially display the food order as “active” for cooking. A subsequent update predicts that the predicted travel time will take an additional 7 minutes before arriving at the kitchen establishment. The AI model and the kitchen coordination application display an alert indicating the changed “on hold” status for the food order. The AI model determines a subsequent instance when the deliver personnel (or delivery vehicle) is predicted to be 5 minutes away from the kitchen establishment, and at that time generates a new alert, which is displayable via the kitchen coordination application, to cook to food order and place the completed food order on on a shelf or pick-up location for the delivery personnel (or the delivery vehicle).

Rule 3: Exclude a given delivery personnel (or delivery vehicle) if their operating shift will end within a threshold time period y. This time period y may be variable and automatically computed using a predicted time to complete preparing a food order, a predicted time to deliver a given food order, and an estimated buffer time. In some cases, the buffer time includes the travel time to return to the kitchen establishment.

Rule 4: Exclude a given delivery personnel (or delivery vehicle) if their operating shift is currently inactive.

Driver or chef performance or availability: In some cases, the AI model prioritizes a delivery personnel with higher performance over a delivery driver with lower performance. For example, a higher performance rating or score is attributed to a delivery personnel that has always made their delivery in time as determined by the computing system 100. In an example scenario in which Delivery Person A has a delivery performance of score 98%, Delivery Person B has a delivery performance of score of 90%, and Delivery Person C has a delivery performance of score 99%, then the AI model is trained to assign a food order to Delivery Person C first, then Delivery Person A, and then Delivery Person B, presuming all drivers are available.

In a similar manner, in some cases, cooks and kitchen staff are tracked for their availability within the kitchen establishment, and their performance is also tracked. Their availability status or performance values, or both, are used by the AI model to prioritize which cook and/or kitchen staff is to prepare a given food order.

Manual Input(s): In some cases, the on-prem server receives inputs originating from kitchen staff or managers regarding the number of equipment available for each station into the system. This information can be updated periodically based on changes in equipment availability or kitchen layout. In some cases, for a make line, if kitchen staff inputs the list of kitchen equipment includes two pizza baking machines, which is data that is storable in the database 118, the AI model is configured to compute that two pizzas can be cooked simultaneously using the two pizza baking machines.

Customer status: In some cases, the AI model analyzes customer behavior patterns and feedback data to dynamically adjust order prioritization based on customer satisfaction metrics. By analyzing customer profiles and order history, the on-prem server adjusts the order prioritization, for example, by prioritizing more “important” customers. Below are some example rules that are executed by the AI model.

Rule 1: If a customer is a VIP (e.g., very important person), a food order from this customer is prioritized first and assigned to an available driver.

Rule 2: If a customer has complained on a past order (or has given a low feedback rating, such as below three stars, to the kitchen establishment for the past order), the current food order from this customer is prioritized first and assigned to an available delivery personnel (or delivery vehicle) rider.

Preparation times across kitchen establishment: In some cases, the AI model computes preparation times for the various food items, and, in some other cases, further correlates the preparation time with other factors (e.g., the type of station in the kitchen establishment used, the kitchen personnel involved, etc.). In some cases, a dynamic preparation time calculation module takes into account real-time operational data from the kitchen coordination application. For example, in alternative to relying on manually input preparation times, the on-prem server continuously updates preparation times based on actual cooking and assembly times recorded by the kitchen coordination application. Below are some example rules executed by the AI model.

Rule 1: Store pre-defined preparation time for each food item in the database 118, and automatically update one or more of these preparation times based on recorded data from the operations of the kitchen coordination application. The database 118 stores the predefined preparation times, the actual recorded preparation times, and the computed estimated preparation times for each food item.

Rule 2: If preparation time is 10 minutes and rider is 10 minutes away but the customer is non VIP, then this food order can be considered for later if there is another valid order with status VIP.

Preparation Time Estimates: In some cases, the AI model takes into account the estimated preparation time for each order when prioritizing. Orders with longer preparation times are started earlier to ensure timely completion, especially during peak hours. In some cases, the peak hours refer to a time range associated with dates (e.g., days of the week, or annual holidays, or both). In some cases, the peak hours is a dynamic parameter that is automatically updated based on historical data of when many orders are concentrated within a period in a day.

Promise time: A promise time herein refers to an estimated time by which the food order will be ready for take away by a customer, or the estimated time at which a food order will be delivered, or the estimate time at which a food order will be served for a dine-in experience, or a combination thereof. In some cases, the AI model calculates promise times dynamically based on various factors including distance, preparation time, traffic conditions, and the order backlog.

Environmental impact: In some cases, the AI model prioritizes food orders and assignment of delivery personnel (or delivery vehicle) based on parameters such as fuel efficiency, carbon emissions, and traffic congestion. In some cases, the AI model aims to reduce the ecological footprint of food delivery operations. In some cases, the AI model will defer a food order to wait for a less traffic heavy condition, or compute a delivery route that reduces carbon emissions, or assigns a delivery personnel (or delivery vehicle) that is fuel efficient.

Real-time Feedback Loop Integration: In some cases, the AI model establishes a real-time feedback loop between customers, drivers, and kitchen staff to continuously improve order prioritization and assignment decisions. In some cases, each event is recorded on the kitchen coordination application, including: bump on make, pack, dispatch, driver delivery, return to store, etc. In some cases, customers can see the order status at any point of time.

Visual Order Complexity Indicator: In some cases, the AI model or the kitchen coordination application, or both, trigger displaying a complexity indicator for each food order on the kitchen coordination application, representing the complexity associated with preparing the food order. In some cases, food orders with a higher complexity, such as customizations or special requests or more modifiers than standard order, are highlighted or color-coded in a GUI of the kitchen coordination application, or moved to shelf if standard orders are in queue as well.

Menu Item Popularity Analysis: In some cases, the AI model or the cloud based analytics server analyzes order data to identify popular menu items or trending dishes. In some cases, the AI model prioritizes orders containing popular food items to capitalize on customer preferences and increase throughput for high-demand items.

Predictive Order Volume Forecasting: In some cases, the AI model or the cloud-based analytics server predicts order volume and demand patterns based on historical data and external factors such as day of the week, time of day, and seasonality. In some cases, the AI model adjusts the order prioritization dynamically to accommodate anticipated demand fluctuations. For example, the AI model predicts or takes into account that in the next 20 minutes more food orders are going to come and the kitchen establishment will likely be busy, so the AI model prioritizes existing orders to provide resource availability (e.g., preparation availability of time, people and equipment) for more food orders to be in queue.

Dynamic Order Processing: In some cases, the AI model dynamically adjusts food order processing based on forecasted demand. In some cases, the AI model batches together multiple food orders to form a grouped food order, to reduce cooking times. In some cases, certain menu items are made temporarily unavailable by the AI model to manage workload and ensure consistent quality.

Early Preparation: In some cases, the AI model computes which food items should be prepared early (or in advance) since these food items are predicted to be in high demand during peak times. For example, if lunchtime is forecasted to be particularly busy, the system suggests, via the GUI of the kitchen coordination application, starting preparations for popular menu items in advance to reduce wait times during peak hours.

In an example scenario, the kitchen coordination application suggests, via the GUI on the on-premise computing devices 120, that at least 10 zinger burgers be made prior to the 1 pm rush period. This suggestion could be in the form of an alert that pops up in the GUI, and is shown at a calculated time in advance of the 1 pm rush period. For example, the AI model computes that each zinger burger takes 10 min to prepare, or 10 zinger burger together takes 15 minutes to prepare (based upon history of preparing the zinger burgers) presuming there are 2 cooks available. Based on this data, and that there are 2 cooks available, the AI model computes that the alert to prepare the 15 zinger burgers in advance of the 1 pm rush should be shown in the GUI at approximately 12:45 pm.

Order Size and Revenue Potential (dine in): In some cases, the AI model prioritizes larger dine in orders (e.g., those with higher revenue potential). While smaller orders may be simpler to prepare, larger orders contribute more to the restaurant's revenue and should be prioritized accordingly.

Dining duration (dine in): In some cases, the AI model considers the dining duration of each table and prioritizes orders for tables that have been seated longer and are more likely to leave soon. In some other cases, the AI model prioritizes the food item for dine-in customers. In some cases, subsequent orders (like a dessert) for the same dine-in customer are prioritized first so that the customer is satisfied and completes their dining experience faster.

Time since order placement (dine in): In some cases, the AI model considers the time since the order placement, gives priority to food orders that have been waiting longer to ensure fairness and reduce overall wait times.

Complexity of the order (dine-in): Orders with fewer items or simpler preparation requirements may be prioritized to ensure faster turnaround times.

Collaborative Order Annotations: In some cases, the on-prem server receives annotations to kitchen orders from the kitchen staff (e.g., via the kitchen coordination application). For example, staff members can flag orders with special requirements or notify colleagues about delays or issues, ensuring clear communication and coordination in the kitchen. Such messages can be sent on an order taking tablet or wearables if in use.

Loyalty Program Data: In some cases, the AI model ingests customer loyalty program data to prioritize orders from loyal customers or those earning rewards points.

In some cases, the prioritization parameters (e.g., including the above-noted prioritization parameters) are part of the ordering application 114, and are selectable by a user for activation. In some cases, the ordering application 114 includes a graphical user interface (GUI) for display. In some cases, the GUI of the ordering application is displayed on the computer 119. The on-prem server 110 provides, via the GUI of the ordering application 114, a plurality of prioritization factors. In some cases, the prioritization factors are available and may be inactive. The on-prem server 110 receives, via the GUI, user input identifying one or more selected prioritization parameters for activation from amongst the plurality of prioritization factors. For example, a user selects one or more prioritization parameters to activate. Responsive to receiving the one or more selected prioritization parameters, the on-prem server 110 re-trains the ML model to apply the one or more selected prioritization factors. The on-prem server then deploys the re-trained ML model to classify a subsequently received a new food order, and, in some cases, to re-order the current set of on-hold food orders. The ordering application 114 facilitates the customization of the AI model 112.

In some cases, the GUI of the ordering application 114 receives ranking data associated with the one or more selected prioritization parameters. For example, the user can order the selected prioritization parameters in a sequence (e.g., a first ranked prioritization parameter, a second ranked prioritization parameter, a third ranked prioritization parameter, etc.) and the AI model is retrained to prioritize the first ranked prioritization parameter over the second ranked prioritization parameter, to prioritize the second ranked prioritization parameter over the third ranked prioritization parameter, and so forth. In some other cases, the ranking data comprises a numerical value that is assigned by the user.

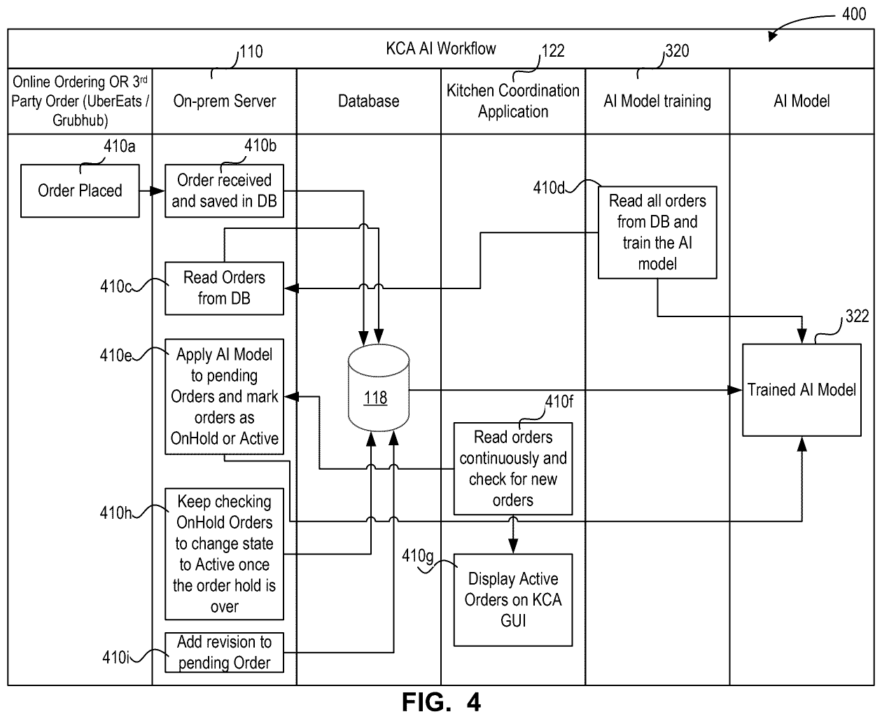

Referring now to FIG. 4, an overall operation process of the computing system 100 is shown. The process 400 is generally identified by reference character 400. In some cases, the process 400 is a more detailed representation of the process 300.

At 410a one or more food order is placed. The one or more food order is received via the ordering application 114, or in the case of an online application, via the one or more ordering API 116 at the on-prem server 110. At 410b the one or more food order is stored in the database 118. At 410c, the one or more food order stored in the database 118 is extracted from the database 118. At 410d, the one or more food order that is extracted from the database 118 is provided to the AI model 112 for training the AI model 112. Other information provided to the AI model 112 includes the preparation time 310b, driver availability 310c, delivery time 310d, VIP indicator 310e, traffic congestion information 310f, and order total 310g. At 410e the trained AI model 322 is applied to pending food orders. The trained AI model 322 provides an order status 332 for each of the pending one or more food order identifying them as either “on hold” or “active”. At 410f the kitchen coordination application 122 at the one or more on-premise computing devices 120 continuously checks for new orders that the trained AI model 322 has provided an order status 332 for. At 410g the one or more food orders are displayed at the one or more on-premise computing devices 120, via the kitchen coordination application 122, with an order status 332 identifying them as either “on-hold” or “active”. At 410h, the on-prem server 110 checks for “on hold” orders changing to “active” and the database 118 is updated. In some cases, the database 118 includes a real-time or near real-time status of all orders.

In some cases, the kitchen coordination application 122 receives one or more inputs (e.g., manually from personnel via a GUI of the kitchen coordination application, or automatically from a device associated with the kitchen establishment, or both) that a given food order that is “active” has been completed, and the kitchen coordination application 122 updates the on-prem server 110, which in turn updates database 118 to reflect the completed order status. For example, when a chef or a cook is finished cooking a food order, the chef or the cook clicks or selects (e.g., by touching a touchscreen) a given active cook order display element in a GUI, which is displayed on the kitchen coordination application 122 of a given on-premise computing device 120. This manual input indicating that an active food order has been completed is herein also called a “bump”. The status update is reflected across all instances of the kitchen coordination application that may be operating on different instances of on-premise computing devices 120 in the kitchen establishment 102. Other data related to the completed order is updated and stored in the database including: time to complete preparation of the order, or time to complete delivery, or materials (e.g., type and amount) consumed to complete preparation of the order, or remaining materials available in the kitchen establishment, or availability of personnel, or availability of kitchen equipment, or personnel involved with the preparation of the order, or personnel involved with the delivery of the order, or a combination thereof.

In some cases, the kitchen coordination application 122 facilitates a cook or a chef to manually override a given food order with an on-hold status, and change the status to an active status (or cook status). In some cases, the kitchen coordination application 122 facilitates a cook or a chef to manually override a given food order with an active status, and change the status to an on-hold status.

In some cases, the on-prem server detects a change of a status of a given order (e.g., changing from an on-hold status to a cook status, or vice versa) and, in response, automatically triggers the AI model to be re-executed to compute a potentially new sequence of the on-hold food orders again. The sequence or the priority order of the on-hold order may be re-sequenced. In some cases, each on-hold order is associated with an estimated time in the future at which the on-hold order status is to change to an active status (or cook status), also herein called an “activate time”. In some cases when automatically triggering the AI model to be re-executed to compute a potentially new sequence of the on-hold food orders again, the activate time associated with each on-hold order is adjusted (e.g., to a later time in the future or to an earlier time in the future).

In some cases, the kitchen coordination application 122 receives one or more inputs (e.g., manually from personnel via a GUI of the kitchen coordination application, or automatically from a device in the kitchen establishment, or both) that a given food order that is “on-hold” is now “active”, and the kitchen coordination application 122 updates the on-prem server 110, which in turn updates database 118 to reflect the active order status. The status update is reflected across all instances of the kitchen coordination application that may be operating on different instances of on-premise computing devices 120 in the kitchen establishment 102. Other data related to the active order status is updated and stored in the database including: time stamp at which the order is started, materials (e.g., type and amount) to be consumed, or availability of personnel, or availability of kitchen equipment, or personnel involved with the preparation of the order, or personnel involved with the delivery of the order, or a combination thereof.

In some cases, the food order itself is revised to add or remove a food item to a food order, or change a location for delivery, or change a time for delivery, or a combination thereof. For example, a customer places a food order, and at a later time the customer communicates with the kitchen establishment to update the food order according to one or more of the previously noted revision. In some cases, at 410i, a revision is added to a pending food order, which is updated in the database 118. After a revision of a given food order has been entered into database 118, the trained AI model 322 is triggered to recalculate the sequence of the food orders, which would include the given food order with the revision. In some cases, the given food order with the revision could take more time or less time to prepare, which could increase or decrease the prioritization.

In some cases, if a revision is added to a food order that has an active status (e.g., cook status), the on prem server adds a label in the GUI of the kitchen coordination application to indicate that the food order has been revised.

In some cases, the trained AI model 322 iteratively retrains using new data recorded in the database 118. The interval at which the trained AI model 322 retrains is a configurable setting in the computer system 100.

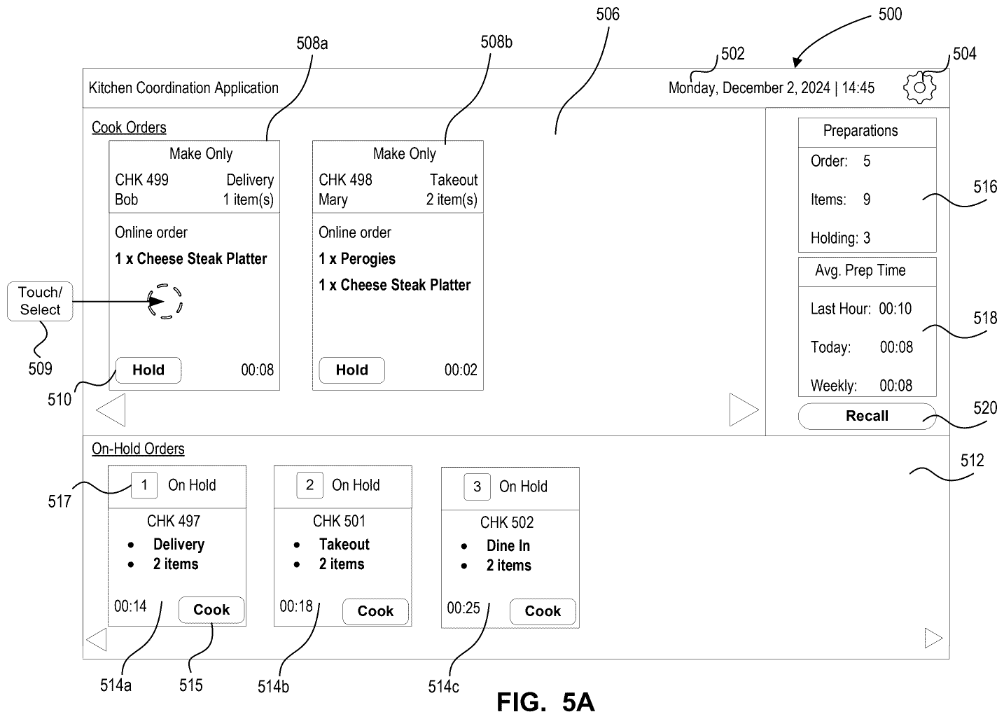

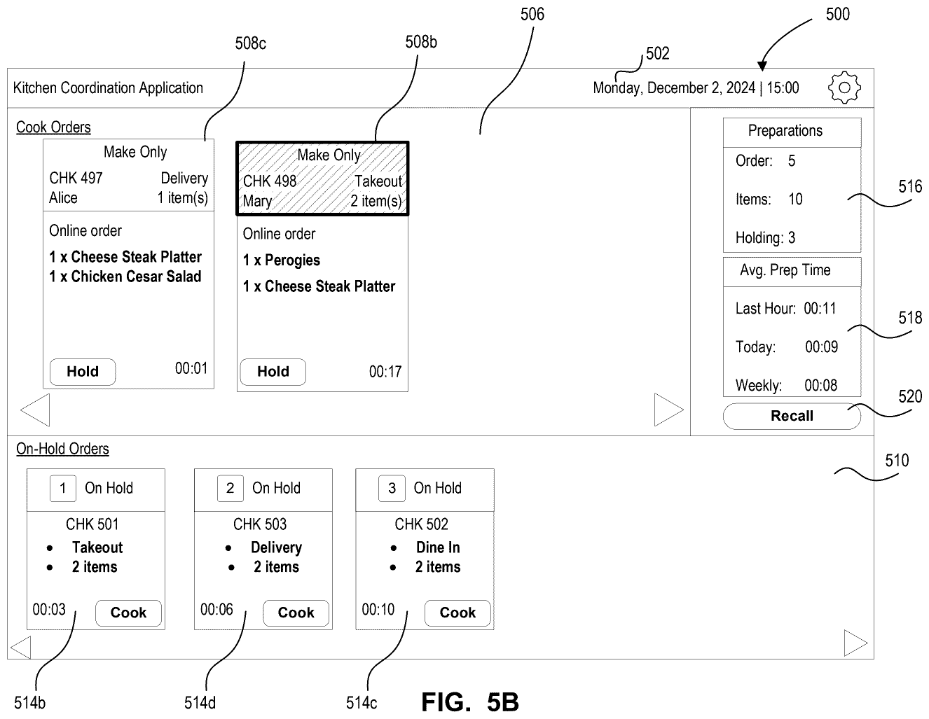

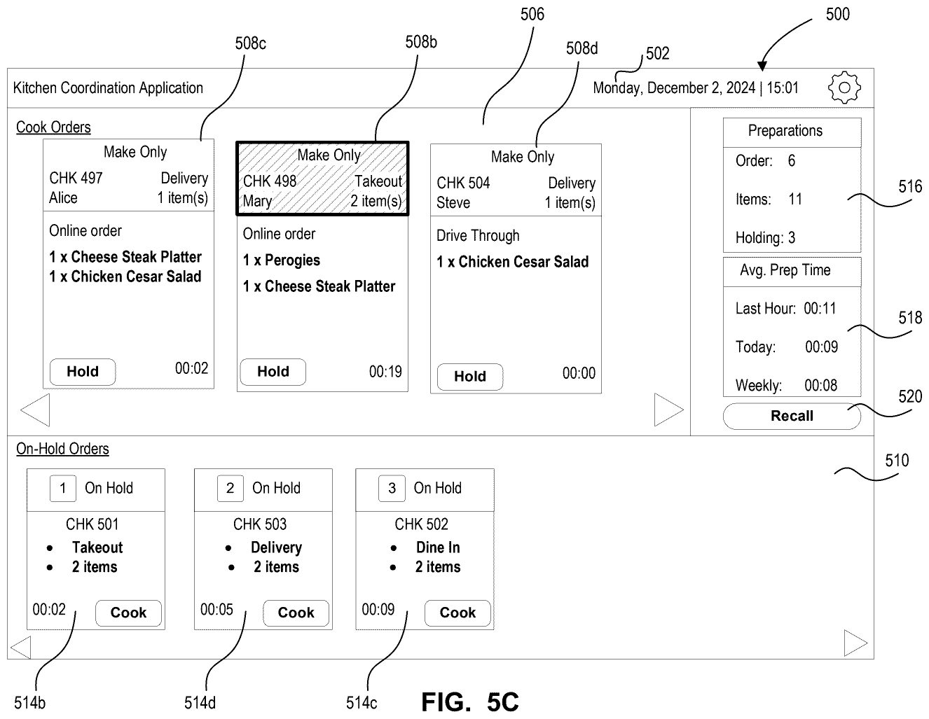

Referring now to FIG. 5A there is provided an example graphical user interface (GUI) 500 of a kitchen coordination application 122 for display at the one or more on-premise computing devices 120, according to at least some embodiments. The GUI 500 illustrates how food orders are presented to kitchen staff at the one or more on-premise computing devices 120. The GUI 500 is designed to enhance visibility and streamline coordination of food order preparation in the kitchen establishment.

The GUI 500 includes current a date and time status 502. In some cases, the GUI 500 includes a settings control 504, which when selected triggers the kitchen coordination application to display a setting GUI for controlling settings of the application.

The GUI 500 includes an active region 506 that includes food orders that have an active status (e.g., food order to be cooked now). In FIG. 5A, there are two active food order panels 508a and 508b. The active food order panel 508a includes a check number or order number (e.g., CHK 499), an indication of the food order type (e.g., Delivery), the number of items (e.g., 1 item), the name of the customer (e.g., Bob), the source of the order (e.g., online order), a quantity and type of food item (e.g. 1× cheese steak platter), and an increasing time counter indicating the amount of time elapsed since the food order has been activated (e.g., 8 minutes, and counting up). In some cases, the active food order panel 508a includes a hold control 510, which when selected causes the kitchen coordination application to change the current status from “active” to “on-hold”. This hold control 510 allows a user (e.g., the cook or chef) to manually override the status of the food order.

Similar information is shown on the active food order panel 508b. For example, the active food order panel 508b includes a check number or order number (e.g., CHK 498), an indication of the food order type (e.g., Delivery), the number of items (e.g., 2 items), the name of the customer (e.g., Mary), the source of the order (e.g., online order), a quantity and type of food item (e.g. 1× perogies and 1× cheese steak platter), and an increasing time counter indicating the amount of time elapsed since the food order has been activated (e.g., 2 minutes, and counting up). In some cases, the food panel 508b includes a hold control.

In some cases, there the active food order panels are not sequenced or prioritized. In some cases, all active food orders are considered a high priority and the kitchen personnel (e.g., chefs or cooks) should be preparing the active food orders.

Each active food order panel 508a, 508b can be selected (e.g., clicked, or touched if using a touchscreen display) by a user. When a selection is detected on a given food order, the given food order is “bumped”, meaning the food order preparation has been completed. In some cases, this automatically causes one or more of the on-hold orders to change its status to “active”. For example, a user (e.g., a chef or cook) provides an input selection 509 using a touch gesture on an area on the food order panel 508a, which changes the status of “active” to a completed food order.

The GUI 500 includes an on-hold region 512 that includes food orders that have an on-hold status. For example, on-hold food order panels 514a, 514b and 514c are in the on-hold region 512, and are sequenced from highest priority to a descending priority.

The on-hold food order panel 514a includes a priority ranking 517 (e.g., 1), an indication that the food order is on-hold, the check or order number (e.g., CHK 497), the order type (e.g., Delivery), the number of food items (e.g., 2 items), and a decreasing time counter indicating a time remaining from now until when the given on-hold food order is expected to automatically switch from an on-hold status to an active status for cooking (e.g., 14 minutes, and counting down). In other words, in 14 minutes from the current time (e.g., 14:45), this food order will automatically change to an active status and appear as an active food order panel in the actice region 506. In some cases, the on-hold food order panel 514a includes a cook control 515, which when selected causes the kitchen coordination application to change the current status from “on-hold” to “active”. This cook control 515 allows a user (e.g., the cook or chef) to manually override the status of the food order.

Similar information is shown in the on-hold food order panel 514b, which is for CHK 501 and has priority ranking 2, and the on-hold food order panel 514c, which is for CHK 502 and has priority ranking 3.

It will be appreciated that the check or order number (e.g., CHK 497, CHK 498, CHK 499, etc.) reflects a unique order ID that, in some cases, increments upwards. The check or order number reflects the sequence in which the food orders are received. In other words, the food order with CHK 497 was received first; then the food order with CHK 498 was received second; the food order with CHK 499 was received third; then food order with CHK 500 was received fourth; and so forth. The AI model computes a new order or new sequence of the food orders based on the data and prioritizations described herein.

In some cases, the GUI 500 includes preparation data 516. For example, the preparation data 516 includes the current number of orders (e.g., 5 orders), the current number of food items (e.g., 9 food items), and the current number of food orders with an on-hold status (e.g., 3 orders on hold).

In some cases, the GUI 500 includes preparation statistics 518. For example, the preparation statistics 518 includes the average preparation time for food orders in the last hour (e.g., an average preparation time of 10 minutes in the last hour), the average preparation time for food orders in the current day so far (e.g., an average preparation time of 8 minutes in the current day so far), and the average preparation time for food orders over the week (e.g., an average preparation time of 8 minutes in the week).

In some cases, the food order panels show timestamps indicating when the order was placed.

In some cases, the food order panels show specific information about the items to be prepared, special requests, and any notes added by the waitstaff or management. For example, the cheese steak platter on the active food order panel 508a may include a special request (e.g., “Add extra cheese”).

The GUI 500 is dynamically updated in real-time as new food orders are ingested by the on-prem server.

Turning to FIG. 5B, the same GUI 500 is shown updated after 15 minutes have elapsed. The current date and time information 502 in the GUI 500 in FIG. 5B shows the time is 15:00, while the previous example GUI 500 in FIG. 5A showed 14:45.

In FIG. 5B, the active food panel 508a is no longer shown, since it has been “bumped”, either automatically by the kitchen coordination application or manually by a user selecting or touching the screen as per input selection 509.

The active food order panel 508b is still shown and the elapsed time since it was activated is now showing 17 minutes. A visual indicator appears on the active food order panel 508b indicating that too much time has passed.

In some cases, the visual indicator is a symbol or text or color. In some cases, the visual indicators automatically change at different time thresholds. For example, if q minutes have passed since the food order was activated, then a first visual indicator is displayed on or associated with the food order; and, if r minutes have passed since the food order was activated, then a second visual indicator is displayed on or associated with the food order, whereby r>q. In some cases, q is 10 minutes and r is 20 minutes. In the example of FIG. 5B, more than 10 minutes has passed since CHK 498 was first activated (i.e., 17 minutes have elapsed), and the active food order panel 508b is shown with a first visual indicator.

The visual indicators are meant to indicate that a given food order is getting old, and a cook should hurry to prepare the food item(s); and/or a given food order is taking too long to prepare, and the cook must urgently prepare the food item(s).

In FIG. 5B, a new active food order panel 508c is shown, which is for the food order represented by CHK 497, and which was previously shown in an on-hold status in FIG. 5A. In some cases, any time an active food order panel is first displayed in the active region 506, an audio or a visual alert is automatically played by the kitchen coordination application.

In FIG. 5B, a new food order has arrived at the on-prem server and has been assigned CHK 503. The AI model has determined that the new food order is classified having an on-hold status, and is to be sequenced as a priority rank 2 in the sequence of on-hold orders; this is reflected at the new on-hold food order panel 514d. The food order panel 514c is reassigned priority rank 3 (e.g., which is a lower rank than its previous priority rank 2 at the time 14:45). In other words, the priority rank of the on-hold food orders is different from the sequence at which the food orders are received.

Referring to FIG. 5C, at a minute later (e.g., at time 15:01) another new food order has arrived at the on-prem server 110, which is assigned the CHK 504. The AI model has determined this new food order (e.g., CHK 504) has a classification as an “active” status (e.g., cook status). Accordingly, an active food order panel 508d is displayed on the GUI 500 for the new food order (e.g., CHK 504). For example, the new food order is a drive through order type and is played as an urgent priority above the pending orders.

In some cases, the cook times for different food items in the same food order are timed so that the food item preparation are finished at the same time. For example, a food order includes a pizza and fries. The pizza cooking time may be 8 min and the fries cooking time may be 2 min, and the system 100 initiates cooking the fries at the sixth minute of pizza cooking so both items are made ready at the same time.

In some cases, indicators for customer feedback are included in the GUI 500, such as ratings or comments. These are included to inform kitchen staff about the importance of specific orders, especially for VIP customers or those with previous complaints. The GUI 500 ensures that kitchen staff have clear, actionable information at their fingertips, enabling efficient and accurate order preparation.

The features of the kitchen coordination application enhances the computer system's 100 ability to manage complex kitchen environments by dynamically adjusting workflows displays and ensuring that resources are allocated efficiently, ultimately improving overall kitchen efficiency and customer satisfaction.

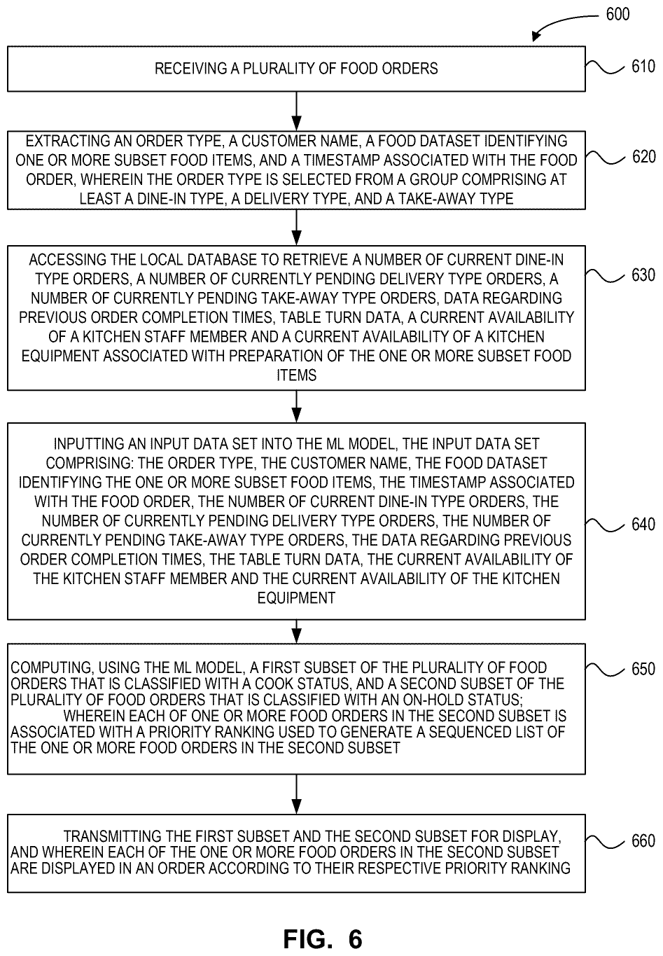

Referring to FIG. 6, there is illustrated a flowchart diagram of an example method performed by the computing system 100. The method is generally identified by reference character 600. In some cases, the method is executed by the on-prem server 110. In some cases, the method further includes operations executed by one or more on-premise computing devices 120, or the computer 119, or other devices in the computing system 100, or a combination thereof.

At block 610 a plurality of food orders is received by the computing system 100. The plurality of food orders are received at either the ordering application 114 or the one or more ordering API 116. The plurality of food orders includes online food orders from online applications and food orders made in person at the kitchen establishment 102.

At block 620 information is extracted from each food order in the plurality of food orders. The information extracted from each food order includes an order type, a customer name, a food dataset identifying one or more subset food items, and a timestamp associated with the food order (e.g., the timestamps indicates the time at which the food order was placed by the customer). In some cases, the order type is selected from a group comprising at least a dine-in type, a delivery type, and a take-away type. In some cases, the group further comprises a drive-through type. Each food order may be stored in the database 118 by the on-prem server 110.

At block 630 the on-prem server 110 accesses the database 118 to obtain information regarding currently pending orders of each order type, and information kitchen resources. In some cases, the on-prem server 110 accesses the database 118 to retrieve a number of current dine-in type orders, a number of currently pending delivery type orders, a number of currently pending take-away type orders, data regarding previous order completion times, and table turn data. In some cases, the information regarding the kitchen resources includes the current availability of kitchen staff and the current availability of kitchen equipment required for the preparation of the one or more subset food items in each food order.

In some cases, the table turn data refers to table turnaround times. In some other cases, the table turn data refers to seat turnover rates, or table turnover rates. In some other cases, the table turn data includes a combination of two or more of: table turnaround times, seat turnover rates, and table turnover rates. In some cases, a table turnaround time refers to the total time a table is used, from when the guests are seated until they leave. In some cases, a seat turnover rate refers to how many times a particular seat is filled during a specific timeframe. In some cases, a table turnover rate refers to the number of times a restaurant's tables are occupied and cleared during a certain time period.

In some cases, a customer loyalty status that is associated with the customer name is extracted. The customer loyalty status is extracted from the restaurant loyalty server 136 by the on-prem server 110 via the one or more ordering API 116. If the customer loyalty status indicates a high loyalty status (i.e., a VIP status), a customization rule may be applied that specifies prioritizing a food order from a customer with a high loyalty status. The customization rule and the customer loyalty status associated with the customer name are provided to the trained AI model 322 as part of an input data set.

At block 650 the collected information for each food order is provided to the trained AI model 322. In some cases, an input data set provided to the trained AI model 322 includes, for each food order: the order type, the customer name, the food dataset identifying the one or more subset food items, the timestamp associated with the food order, the number of current dine-in type orders, the number of currently pending delivery type orders, the number of currently pending take-away type orders, the data regarding previous order completion times, the table turn data, the current availability of the kitchen staff member and the current availability of the kitchen equipment.

At block 650 the trained AI model 322 computes two subsets with different classifications from amongst the plurality of food orders. A first subset of the plurality of food orders is classified by the trained AI model with an “active” order status (also called a cook status). A second subset of the plurality of food orders is classified by the trained AI model with an “on hold” order status, indicating that these food orders are to be held.

In some cases, each of the one or more food orders in the second subset is associated with a priority ranking, which is used to generate a sequenced list of the one or more food orders in the second subset.

In some cases, each food order in the second subset of the sequenced list is provided with a reason for the “on hold” order status 332 in a text format. The trained AI model 322 determines the holding reason. The holding reason can include, for example, waiting for a specific ingredient, a higher priority food order takes precedence, a kitchen resource constraint, or a combination thereof. In some cases, the reason for the “on hold” status is in a natural language format, and is displayed with the on-hold order on the kitchen coordination application GUI.

In some cases, when a new food order is received, the trained AI model 322 is re-executed. Information from the new food order and at least the second subset of the plurality of food orders in the sequenced list is used by the trained AI model 322 to compute a new sequenced list, wherein the new sequenced list comprises the new food order. The new food order is assigned an order status identifying it as either an “active” food order or an “on hold” food order.

In some cases, each food order of the plurality of food orders in the second subset in the sequenced list has an estimated release time for when the “on hold” status will transition to the “active” or cook status. The trained AI model computes the estimated release time.

In some cases, the first subset of the plurality of food orders includes a first food item that is part of a given food order with a cook status, and the second subset of the plurality of food orders includes a second food item that is part of the same given food order. The first food item may be associated with a first preparation time x and the second food item may be associated with a second preparation time y that is less than the first preparation time x. The “on-hold” status of the second food item may be transitioned to the “active” or cook status approximately (x-y) minutes after receiving an indication that the first food item has started being prepared. In some cases, the indication may be provided via a manual input to the kitchen coordination application 122 by kitchen staff confirming preparation has commenced.

At block 660 the first subset of the plurality of food orders is sent to the one or more on-premise computing devices 120. Kitchen staff are able to view and interact with the kitchen coordination application 122 on the one or more on-premise computing devices 120. In some cases, the one or more food orders in the second subset are also transmitted for display on the on-premise computing devices 120.

In some cases, the method 600 further includes the trained AI model 322 computing a food order volume forecast with a predictive machine learning model. In some cases, the method 600 further includes executing the predictive machine learning model to further compute a pattern associated with the food order volume forecast.

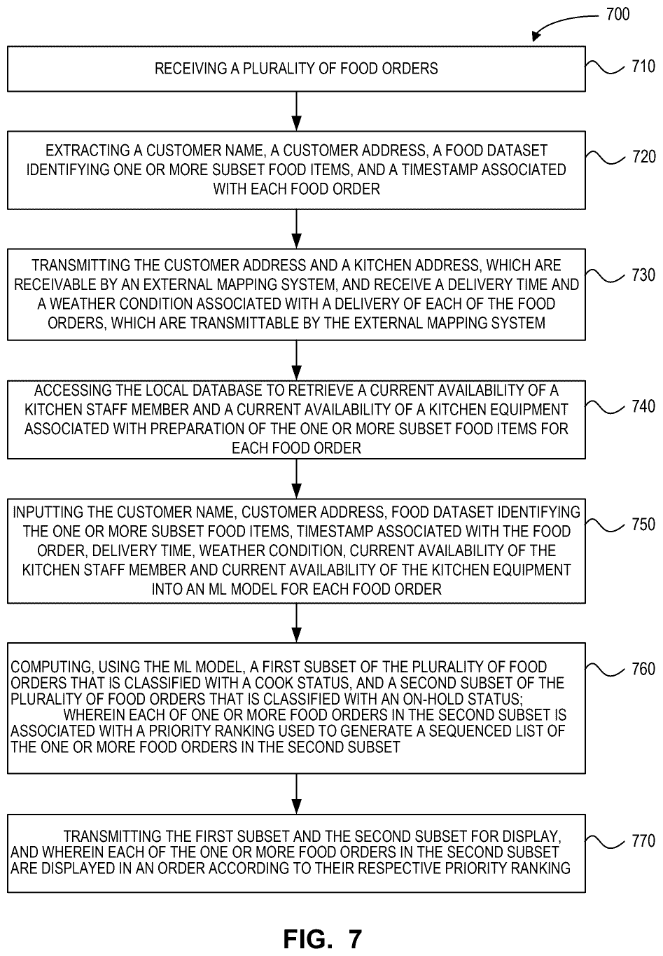

Referring to FIG. 7, there is illustrated a flowchart diagram of another example method performed by the computing system 100. The method is generally identified by reference character 700. In some cases, the method 700 is executed by the on-prem server 110.

At block 710 a plurality of food orders is received by the computing system 100. The plurality of food orders are received at either the ordering application 114 or the one or more ordering API 116. The plurality of food orders includes online food orders from online applications and food orders made in person at the kitchen establishment 102.

At block 720 information is extracted from each food order in the plurality of food orders. The information extracted from each food order includes the customer name, the customer address, a food dataset which identifies one or more subset food items, and a timestamp indicating the time at which the food order was placed. Each food order may be stored in the database 118 by the on-prem server 110.

At block 730 the on-prem server 110 transmits information to the external data sources 130. The customer address for each food order and the address of the kitchen establishment 102 are sent to the map and weather servers 134. The on-prem server 110 receives a delivery time and weather conditions from the map and weather server 134 for each food order. The on-prem server 110 interfaces with the map and weather servers 134 via the one or more ordering API 116 for sending and receiving data.

At block 740 the on-prem server 110 accesses the database 118 to obtain information regarding kitchen resources. The information regarding the kitchen resources includes the current availability of kitchen staff and the current availability of kitchen equipment required for the preparation of the one or more subset food items in each food order.

In some cases, a customer loyalty status that is associated with the customer name is extracted. The customer loyalty status is extracted from the restaurant loyalty server 136 by the on-prem server 110 via the one or more ordering API 116. If the customer loyalty status indicates a high loyalty status (i.e., a VIP status), a customization rule may be applied that specifies prioritizing a food order from a customer with a high loyalty status. The customization rule and the customer loyalty status associated with the customer name are provided to the trained AI model 322.

At block 750 the collected information for each food order is provided to the trained AI model 322. The information provided to the trained AI model 322 includes, for each food order: the customer name, the customer address, the food dataset identifying the one or more subset food items, the timestamp, the delivery time, the weather conditions, the current availability of kitchen staff and the availability of the kitchen equipment.

At block 760 the trained AI model 322 computes two subsets with different classifications from amongst the plurality of food orders. A first subset of the plurality of food orders is classified by the trained AI model with an “active” order status (also called a cook status). A second subset of the plurality of food orders is classified by the trained AI model with an “on hold” order status, indicating that these food orders are to be held.

In some cases, each of the one or more food orders in the second subset is associated with a priority ranking, which is used to generate a sequenced list of the one or more food orders in the second subset.

In some cases, each food order in the second subset of the sequenced list is provided with a reason for the “on hold” order status 332 in a text format. The trained AI model 322 determines the holding reason. The holding reason can include, for example, waiting for a specific ingredient, a higher priority food order takes precedence, a kitchen resource constraint, or a combination thereof.

As used herein, an element or feature introduced in the singular and preceded by the word “a” or “an” should be understood as not necessarily excluding the plural of the elements or features. Further, references to “one example” or “one embodiment” are not intended to be interpreted as excluding the existence of additional examples or embodiments that also incorporate the described elements or features. Reference herein to “example” means that one or more feature, structure, element, component, characteristic and/or operational step described in connection with the example is included in at least one embodiment and/or implementation of the subject matter according to the subject disclosure. Thus, the phrases “an example,” “another example” and similar language throughout the subject disclosure may, but do not necessarily, refer to the same example. Further, the subject matter characterizing any one example may, but does not necessarily, include the subject matter characterizing any other example.

Unless explicitly stated to the contrary, examples or embodiments “comprising” or “having” or “including” an element or feature or a plurality of elements or features having a particular property may include additional elements or features not having that property. Also, it will be appreciated that the terms “comprises”, “has”, “includes” means “including but not limited to” and the terms “comprising”, “having” and “including” have equivalent meanings.

As used herein, the term “and/or” can include any and all combinations of one or more of the associated listed elements or features.

It will be understood that when an element or feature is referred to as being “on”, “attached” to, “affixed” to, “connected” to, “coupled” with, “contacting”, etc. another element or feature, that element or feature can be directly on, attached to, connected to, coupled with or contacting the other element or feature or intervening elements may also be present. In contrast, when an element or feature is referred to as being, for example, “directly on”, “directly attached” to, “directly affixed” to, “directly connected” to, “directly coupled” with or “directly contacting” another element of feature, there are no intervening elements or features present.

It will be understood that spatially relative terms, such as “under”, “below”, “lower”, “over”, “above”, “upper”, “front”, “back” and the like, may be used herein for ease of description to describe the relationship of an element or feature to another element or feature as illustrated in the figures. The spatially relative terms can however, encompass different orientations in use or operation in addition to the orientation depicted in the figures.

Reference herein to “configured” denotes an actual state of configuration that fundamentally ties the element or feature to the physical characteristics of the element or feature preceding the phrase “configured to.”

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of a lower-numbered item (e.g., a “first” item) and/or a higher-numbered item (e.g., a “third” item).

As used herein, the terms “approximately” and “about” represent an amount close to the stated amount that still performs the desired function or achieves the desired result. For example, the terms “approximately” and “about” may refer to an amount that is within engineering tolerances that would be readily appreciated by a person skilled in the art. Although embodiments have been described above with reference to the accompanying drawings, those of skill in the art will appreciate that variations and modifications may be made without departing from the scope thereof as defined by the appended claims.

What is claimed is:

1. An on-premise computing system comprising:
a communication system configured to receive a plurality of food orders and to communicate with one or more on-premise display devices;
a memory comprising a machine learning (ML) model, and a local database configured to store kitchen staff status data and kitchen equipment status data;
a processor configured to:
for each food order:
extract an order type, a customer name, a food dataset identifying one or more subset food items, and a timestamp associated with the food order, wherein the order type is selected from a group comprising at least a dine-in type, a delivery type, and a take-away type;
access the local database to retrieve a number of current dine-in type orders, a number of currently pending delivery type orders, a number of currently pending take-away type orders, data regarding previous order completion times, table turn data, a current availability of a kitchen staff member and a current availability of a kitchen equipment associated with preparation of the one or more subset food items;
input an input data set into the ML model, the input data set comprising: the order type, the customer name, the food dataset identifying the one or more subset food items, the timestamp associated with the food order, the number of current dine-in type orders, the number of currently pending delivery type orders, the number of currently pending take-away type orders, the data regarding previous order completion times, table turn data, the current availability of the kitchen staff member and the current availability of the kitchen equipment;
compute, using the ML model, a first subset of the plurality of food orders that is classified with a cook status, and a second subset of the plurality of food orders that is classified with an on-hold status;
wherein each of the food orders in the second subset is associated with a priority ranking used to generate a sequenced list of the food orders in the second subset; and
transmit the first subset and the second subset for display on the one or more on-premise display devices, and wherein each of the food orders in the second subset are displayed in an order according to their respective priority ranking.

2. The on-premise computing system of claim 1, wherein each of the one or more food orders in the first subset is displayed respectively with one or more increasing time counters indicating a time elapsed since each of the one or more food orders in the first subset was classified with the cook status.

3. The on-premise computing system of claim 1, wherein the ML model computes, for each of the one or more food orders in the second subset, one or more estimated future times at which each respective on-hold status will automatically change to the cook status; and wherein each of the one or more food orders in the second subset is displayed respectively with one or more decreasing time counters each indicating a time remaining to the respective estimated future time at which the on-hold status will automatically change to the cook status.

4. The on-premise computing system of claim 3, wherein, when a current time matches a given estimated future time associated with a given food order in the second subset, the given food order in the second subset is reclassified with the cook status and moved into the first subset.

5. The on-premise computing system of claim 1, wherein each of the one or more food orders in the second subset is further associated with a holding reason, and wherein the ML model computes the holding reason.

6. The on-premise computing system of claim 5, wherein the holding reason is in a natural language format, and the holding reason is displayed respectively with each of the one or more food orders in the second subset.

7. The on-premise computing system of claim 5, wherein the holding reason comprises: waiting for a specific ingredient, a higher priority food order takes precedence, a kitchen resource constraint, or a combination thereof.

8. The on-premise computing system of claim 1, wherein the communication system is configured to communicate with an external mapping system, and wherein the processor is configured to further:
extract a customer address associated with each food order;
when the order type is the delivery type, transmit the customer address and a kitchen address, which are receivable by the external mapping system, and, in response, receive a delivery time and a weather condition associated with a delivery of the food order, which are transmittable by the external mapping system; and
wherein the input data set further comprises the customer address, the delivery time and the weather condition.

9. The on-premise computing system of claim 1, when a new food order is received, the processor is configured to automatically re-execute the ML model using the new food order and at least the second subset of the plurality of food orders to compute a new sequenced list, wherein the new sequenced list comprises the new food order that is associated with the on-hold status.

10. The on-premise computing system of claim 1, wherein the first subset of the plurality of food orders comprises a first food item that is part of a given food order;
the second subset of the plurality of food orders comprises a second food item that is part of the given food order; the first food item is associated with a first preparation time x;
the second food item is associated with a second preparation time y that is less than the first preparation time x; and
the processor is configured to change the hold status of the second food item to the cook status approximately (x-y) minutes after receiving an indication that the first food item has started being prepared.

11. The on-premise computing system of claim 1, wherein the processor extracts a customer loyalty status associated with the customer name;
the local database comprises a customization rule specifying to prioritize a given food order with a high loyalty status; and
the customization rule and the customer loyalty status associated with the customer name are inputted into the ML model.

12. The on-premise computing system of claim 1, wherein the processor provides an ordering application comprising a graphical user interface (GUI) for display, and the processor is further configured to: provide, via the GUI, a plurality of prioritization parameters; receive, via the GUI, user input identifying one or more selected prioritization parameters for activation from amongst the plurality of prioritization parameters; re-train the ML model to apply the one or more selected prioritization parameters; and deploy the re-trained ML model at least when subsequently receiving a new food order.

13. The on-premise computing system of claim 1, wherein the memory further comprises a predictive ML model, and the processor is configured to execute the predictive ML model to compute a food order volume forecast.

14. The on-premise computing system of claim 13, wherein the processor is configured to execute the predictive ML model to further compute a pattern associated with a food order volume forecast.

15. The on-premise computing system of claim 1, wherein the processor is configured to:
receive a natural language user input requesting analytics information;
use a large language model to generate a structured query based on the natural language user input;
use the structured query to obtain structured data from a database that stores thereon preparation metrics associated with the plurality of food orders;
process the structured data using the large language model to generate at least a natural language explanation responsive to the natural language user input; and
output the natural language explanation.

16. A method executed in a computing environment comprising one or more processors and memory, the method comprising:
receiving a plurality of food orders and to communicate with one or more on-premise display devices;
for each food order from the plurality of food orders:
extracting an order type, a customer name, a food dataset identifying one or more subset food items, and a timestamp associated with the food order, wherein the order type is selected from a group comprising at least a dine-in type, a delivery type, and a take-away type;
accessing a local database to retrieve a number of current dine-in type orders, a number of currently pending delivery type orders, a number of currently pending take-away type orders, data regarding previous order completion times, table turn data, a current availability of a kitchen staff member and a current availability of a kitchen equipment associated with preparation of the one or more subset food items;
inputting an input data set into a machine learning model, the input data set comprising: the order type, the customer name, the food dataset identifying the one or more subset food items, the timestamp associated with the food order, the number of current dine-in type orders, the number of currently pending delivery type orders, the number of currently pending take-away type orders, the data regarding previous order completion times, table turn data, the current availability of the kitchen staff member and the current availability of the kitchen equipment;
computing, using the ML model, a first subset of the plurality of food orders that is classified with a cook status, and a second subset of the plurality of food orders that is classified with an on-hold status;
wherein each of the food orders in the second subset is associated with a priority ranking used to generate a sequenced list of the food orders in the second subset; and
transmitting the first subset and the second subset for display on one or more on-premise display devices, and wherein each of the food orders in the second subset are displayed in an order according to their respective priority ranking.

17. The method of claim 16, further comprising displaying each of the one or more food orders in the first subset respectively with one or more increasing time counters indicating a time elapsed since each of the one or more food orders in the first subset was classified with the cook status.

18. The method of claim 16, further comprising:
using the ML model to compute, for each of the one or more food orders in the second subset, one or more estimated future times at which each respective on-hold status will automatically change to the cook status; and
displaying each of the one or more food orders in the second subset respectively with one or more decreasing time counters that each indicate a time remaining to the respective estimated future time at which the on-hold status will automatically change to the cook status.

19. The method of claim 18, wherein, when a current time matches a given estimated future time associated with a given food order in the second subset, the given food order in the second subset is reclassified with the cook status and moved into the first subset.

20. The method of claim 16, wherein each of the one or more food orders in the second subset is further associated with a holding reason, and wherein the ML model computes the holding reason.

21. The method of claim 20, wherein the holding reason is in a natural language format, and the method further comprises displaying the holding reason respectively with each of the one or more food orders in the second subset.

22. The method of claim 16, further comprising, when the food order type is the delivery type:
extracting a customer address;
transmitting the customer address and a kitchen address, which are receivable by a external mapping system, and, in response, receiving a delivery time and a weather condition associated with a delivery of the food order, which are transmittable by the external mapping system; and
wherein the input data set further comprises the customer address, the delivery time and the weather condition.

23. The method of claim 16, further comprising: when a new food order is received, automatically re-executing the ML model using the new food order and at least the second subset of the plurality of food orders to compute a new sequenced list, wherein the new sequenced list comprises the new food order that is associated with the on-hold status.

24. The method of claim 16, wherein the first subset of the plurality of food orders comprises a first food item that is part of a given food order;
the second subset of the plurality of food orders comprises a second food item that is part of the given food order; the first food item is associated with a first preparation time x;
the second food item is associated with a second preparation time y that is less than the first preparation time x; and
the method further comprises changing the hold status of the second food item to the cook status approximately (x-y) minutes after receiving an indication that the first food item has started being prepared.

25. The method of claim 16, wherein the local database comprises a customization rule specifying to prioritize a given food order with a high loyalty status; and
the method further comprising:
extracting a customer loyalty status associated with the customer name; and
inputting the customization rule and the customer loyalty status associated with the customer name into the ML model.

26. The method of claim 16, wherein the computing environment comprises an ordering application comprising a graphical user interface (GUI) for display, and the method further comprising: providing, via the GUI, a plurality of prioritization parameters; receiving, via the GUI, user input identifying one or more selected prioritization parameters for activation from amongst the plurality of prioritization parameters; re-training the ML model to apply the one or more selected prioritization parameters; and deploying the re-trained ML model at least when subsequently receiving a new food order.

27. The method of claim 16, wherein the memory further comprises a predictive ML model, and the method further comprising executing the predictive ML model to compute a food order volume forecast.

28. The method of claim 27, further comprising executing the predictive ML model to further compute a pattern associated with a food order volume forecast.

29. The method of claim 16, further comprising:
receiving a natural language user input requesting analytics information;
using a large language model to generate a structured query based on the natural language user input;
using the structured query to obtain structured data from a database that stores thereon preparation metrics associated with the plurality of food orders;
processing the structured data using the large language model to generate at least a natural language explanation responsive to the natural language user input; and
outputting the natural language explanation.

30. A non-transitory computer readable medium storing instructions that, when executed by a processor, cause the processor to perform a method comprising:
receiving a plurality of food orders and to communicate with one or more on-premise display devices;
for each food order from the plurality of food orders:
extracting an order type, a customer name, a food dataset identifying one or more subset food items, and a timestamp associated with the food order, wherein the order type is selected from a group comprising at least a dine-in type, a delivery type, and a take-away type;
accessing a local database to retrieve a number of current dine-in type orders, a number of currently pending delivery type orders, a number of currently pending take-away type orders, data regarding previous order completion times, table turn data, a current availability of a kitchen staff member and a current availability of a kitchen equipment associated with preparation of the one or more subset food items;
inputting an input data set into the ML model, the input data set comprising: the order type, the customer name, the food dataset identifying the one or more subset food items, the timestamp associated with the food order, the number of current dine-in type orders, the number of currently pending delivery type orders, the number of currently pending take-away type orders, the data regarding previous order completion times, table turn data, the current availability of the kitchen staff member and the current availability of the kitchen equipment;
computing, using the ML model, a first subset of the plurality of food orders and a subset that is classified with a cook status, and a second subset of the plurality of food orders that is classified with an on-hold status;
wherein each of the food orders in the second subset is associated with a priority ranking used to generate a sequenced list of the food orders in the second subset; and
transmitting the first subset and the second subset for display on one or more on-premise display devices, and wherein each of the food orders in the second subset are displayed in an order according to their respective priority ranking.
